(19) United States
(12) Patent Application Publication
(10) Pub. No.: US 2006/0002565 A1
(43) Pub. Date: Jan. 5, 2006

(54) Key management system and playback apparatus

(76) Inventor: Itaru Takemura, Saitama (JP)

Correspondence Address: YOUNG & THOMPSON, 745 SOUTH 23RD STREET, 2ND FLOOR, ARLINGTON, VA, 22202, US

(21) Appl. No.: 11/131,296

(22) Filed: May 18, 2005

(30) Foreign Application Priority Data
May 18, 2004 (JP) 2004-147985

(51) Int. Cl. H04L 9/00

(52) U.S. Cl. 380/286

(57) ABSTRACT

The Information providing system includes a key management center, information transmitter and information receiver. The key management center assigns, to the receivers, confidential information and public information for decrypting the encrypted information transmitted by the information transmitter. The key management center determines the set of the receivers for which decryption of the encrypted information is not permitted, generates key information that can be decrypted only by the receivers other than the set, and transmits the key information with the information encryption key for encrypting the transmission information to the information receivers. The information transmitter encrypts the transmission information with the information encryption key of the transmission information to produce the encrypted information, and transmits it to the information receivers with the key information.

### BACKGROUND OF THE INVENTION

1. Field of the Invention

This invention relates to a key management system using a tree structure and having a function of revoking a specific receiver.

2. Description of Related Art

In order to protect copyright of contents being literary works such as a movie and music, it is broadly carried out that contents are provided after being encrypted. In an example of such a system, plural decryption keys (i.e., device keys) or confidential information for generating decryption keys are given to a receiver or a playback apparatus (hereinafter referred to as “information receiver” or “receiver”). On the other hand, the encrypted contents and the key information, by which only a playback apparatus permitted to play back the contents can generate a decryption key of the contents, are transmitted via a network or supplied to the information receiver in a manner recorded on a recording medium. The receiver and the playback apparatus permitted to play back the contents generate the decryption key of the contents from its own confidential information and the key information thus received, and decrypts the contents by using the decryption key to play back them. On the contrary, since a receiver or a playback apparatus which is not permitted to play back the contents (revoked) cannot generate the decryption key of the contents, it cannot play back the encrypted contents.

Supposing a general equipment as a receiving apparatus or a playback apparatus, it is not very favorable that the apparatus has the function of altering its own confidential information because the manufacturing cost of the apparatus increases and the security of storing the confidential information may be deteriorated. Therefore, a system is desired which meets a receiving apparatus or a playback apparatus which does not have the function of altering the decryption key. If the receiving apparatus or the playback apparatus has the function of altering the decryption key, the apparatus can use the decryption key obtained at a certain point of time to obtain the key information transmitted thereafter, and hence the communication amount can be reduced. However, the apparatus which does not have the function of altering the decryption key only possesses the decryption key given at an initial time (e.g., at the time the apparatus is manufactured). Therefore, when the information transmitter (sender) transmits the key generation information, it must transmit, every time, information by which the apparatus can obtain the decryption key of the contents by using only that decryption key.

In such a system, there is proposed a key management system using a tree structure as a technique of managing key information. As examples thereof, there are known “The Complete Sub-tree Method”, “The Subset Difference Method” and “Master Key Method” (see. Document-1: Tomoyuki Asano, “A revocation scheme with minimal storage at receivers”, Lecture Notes in Computer Science, Vol. 2501, pp 433-450, 2002”). In these systems, when the key generation information for generating the decryption key of the contents is illegally disclosed or leaked, a process of revoking the key generation information is possible.

However, in the above key management systems, since the receivers are assigned to the leaves of the constructed tree structure, the upper limit of the number of the receivers for the entire system is restricted. Therefore, once the tree structure is constructed and the operation of the system is stated, no further receiver can be added to the system beyond the upper limit.

In this view, for example, the key management system described in the Document-2 (Japanese Patent Application Laid-Open under No. 2003-204321) solves the above problem by using the Tree Pattern Division Method as the base and employing a method of adding the receivers to the system without upper limit. Specifically, if the number of the leaves in the tree structure to which no receiver is assigned is larger than a predetermined threshold, the receiver is simply added to the leaves. On the contrary, if the number of leaves to which no receiver is assigned is smaller than the threshold, a layer is provided under the leaf to which no receiver is assigned, so as to make new leaves, and the receivers are assigned to those new leaves.

However, in the key management system described in the Document-2, since the layer is provided under the leaf to which no receiver is assigned thereby to make new leaves and the receivers are assigned those new leaves, the newer receivers are assigned to the deeper layers when the addition of the receiver is repeated. Also, in the Tree Pattern Division Method used as the base, plural decryption keys are assigned to the internal nodes of the tree structure, and the receiver must store the decryption keys assigned to all the nodes existing on a path from the leaf to which the receiver is assigned to the root. Namely, since the number of the decryption keys the receiver must own is proportional to the depth of the layer of the tree structure at which the leaf of the receiver exists, there is a problem that the newly added receiver must store larger number of decryption keys.

Further, in the Tree Pattern Division Method, the amount of the key information transmitted to revoke the receiver becomes larger as the layer of the tree structure is deeper. Therefore, in the key management system described in the Document-2, the amount of transmitted key information to revoke the receiver existing at the time of starting the operation of the system is small, but a large number of key information must be transmitted to revoke the receiver added latest and assigned to the leaf located at the lowest layer.

### SUMMARY OF THE INVENTION

The above may be cited as an example of a problem to be solved by the invention. The present invention provides a key management system using tree structure capable of infinitely adding receivers to the system, without the increase of confidential information stored in the receiver and transmitted key information. The present invention also provides a playback apparatus capable of decrypting the key encrypted by the above key management system.

According to one aspect of the present invention, there is provide a key management apparatus for generating key information in association with a tree structure which has at least one root node and in which plural nodes are assigned under a node as leaves, including: a first storage unit which stores natural numbers relatively prime to each other, as public information, in association with a subset expressed by a combination of plural leaves corresponding to each of nodes constituting the tree structure; a second storage unit which stores master keys in association with the leaves corresponding to the node; a third storage unit which stores encryption/decryption key in association with the subset; and a unit which assigns receivers to lowest nodes of the tree structure; a first expansion unit which expands a new leaf to one of the lowest nodes of the tree structure to which the receiver is not assigned and assigns the encryption/decryption key to the new leaf.

The above key management system aims to protect copyrights of the contents, and uses tree structure as a technique of managing the key information. An information providing system employing this key management system is constructed by a key management center, an information transmitter and an information receiver. The above key management apparatus may function as a key management center in the key management system (the key management apparatus is also referred to as “key management center”). The key management center assigns confidential information and public information to decrypt the encrypted information transmitted by the information transmitter (e.g., a “recording apparatus” which records contents on a “recording medium”) to each of the information receivers (e.g., a “playback apparatus” which plays back the contents recorded on the “recording medium”). The key management center determines the set of the receivers for which the decryption of the encrypted information becomes impossible, and generates the key information by which the receivers other than the set can decrypt the encrypted information. The key management center delivers the key information to the information transmitter together with the information encryption key used to encrypt the transmission information. The information transmitter encrypts the transmission information by using the information encryption key of the transmission information delivered from the key management center to produce the encrypted information, and transmits the encrypted information to the receiver together with the key information. The receiver who is not revoked (hereinafter also referred to as “non-revoked receiver”) receives the encrypted information, calculates the information decryption key from the confidential information and the public information stored in the receiver and the key information thus received, and decrypts the received information from the encrypted information by using the information decryption key.

The key management apparatus has a first storage unit which stores natural numbers relatively prime to each other, as public information, in association with a subset expressed by a combination of plural leaves corresponding to each of nodes constituting the tree structure. Further, the key management apparatus has a second storage unit which stores master keys in association with the leaves corresponding to the node, and a third storage unit which stores encryption/decryption key in association with the subset. The information encryption key and the information decryption key (session key) are calculated by the decryption key derived from the master key. The key management apparatus has a unit which assigns receivers to lowest nodes of the tree structure, and expands a new leaf to one of the lowest nodes of the tree structure to which the receiver is not assigned and assigns the encryption/decryption key to the new leaf. Namely, when a new receiver is added, one or more leaf is generated from the leaf to which the receiver is not assigned, thereby to expand the tree structure. Thus, the tree structure can be readily expanded in accordance with the number of the new receivers to be added. Therefore, by expanding the tree structure, the number of the nodes included in the tree structure can be minimized under the necessity, and the key management center can reduce the computational amount when the master keys and the encryption/decryption keys are assigned to the nodes.

According to another aspect of the present invention, there is provided a key management apparatus for generating key information in association with a tree structure which has at least one root node and in which plural nodes are assigned under a node as leaves, including: a first storage unit which stores natural numbers relatively prime to each other, as public information, in association with a subset expressed by a combination of plural leaves corresponding to each of nodes constituting the tree structure; a second storage unit which stores master keys in association with the leaves corresponding to the node; a third storage unit which stores encryption/decryption key in association with the subset; and a second expansion unit which generates a new node having the root node as a leaf, adds a tree structure having the new node as the root node, and calculates master keys to be assigned to each nodes of the added tree structure.

The above key management apparatus sets a new node which includes the root node of the tree structure as a child node, and generates a tree having the newly set parent node as the root node. Thereby, all receivers belong to the same layer of the tree structure, and the number of the master keys and the encryption/decryption keys are the same for all the receivers. Therefore, there is no difference in the computational amount to calculate the encryption/decryption keys among the receivers.

Preferably, the key management apparatus may further include: a fourth storage unit which stores a composite number which is a product of more than one arbitrary prime numbers; a fifth storage unit which stores confidential information which is an arbitrary natural number which is smaller than the composite number and which is relatively prime to the composite number, in association with the root node; a first operation unit which calculates the master key by a bijective function from the confidential information and the public information; and a second operating unit which calculates the encryption/decryption key based on the master key and the public information.

In this case, it is preferred that Pseudo Random Permutation (PRP) is used as the bijective function. If it is used, the relationship between the encryption/decryption keys assigned to the subsets defined to the nodes in a parent-child relation has no correlation. Therefore, the copyright of the contents can be securely protected.

Further, in the similar aspect of the present invention, the key management method and the key management program can provide the same advantage as that of the above key management apparatus.

The nature, utility, and further features of this invention will be more clearly apparent from the following detailed description with respect to preferred embodiment of the invention when read in conjunction with the accompanying drawings briefly described below.

### BRIEF DESCRIPTION OF THE DRAWINGS

FIG. 1 is a diagram showing an example of an information providing system to which a key management system is applied;

FIG. 2 is a diagram showing another example of an information providing system to which a key management system is applied;

FIG. 3 is a diagram showing still another example of an information providing system to which a key management system is applied;

FIG. 4 is a diagram showing an example of a tree structure used for the key management system;

FIG. 5 shows examples of encryption/decryption keys assigned to the nodes in a key management system according to a basic method;

FIG. 6 shows a method of dividing a set N\R in the key management system;

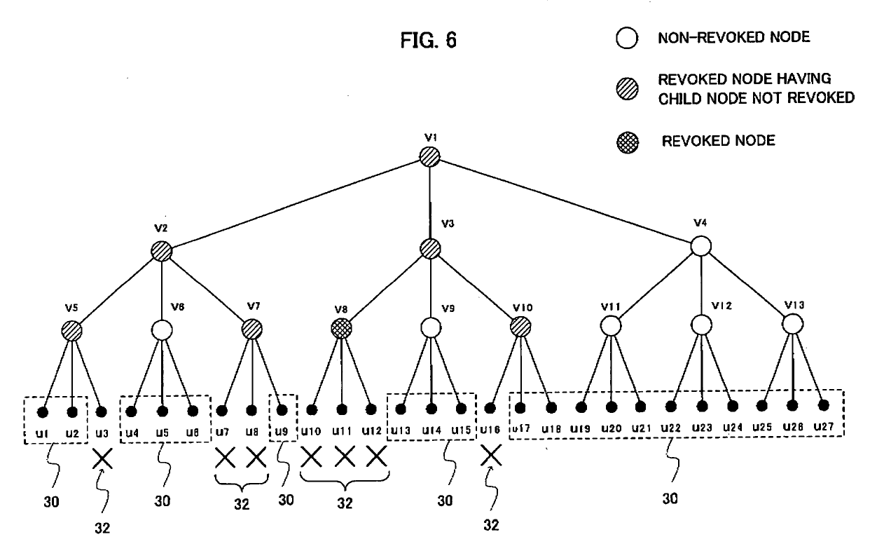

FIG. 7 shows examples of encryption/decryption keys assigned to the nodes in a key management system according to an embodiment of the invention;

FIG. 8 shows other examples of encryption/decryption keys assigned to the nodes in a key management system according to an embodiment of the invention;

FIG. 9 is a diagram showing a method of calculating encryption/decryption keys in a key management system according to the embodiment of the invention;

FIGS. 10(a) and 10(b) show an example of system expansion method according to a first embodiment of the invention;

FIGS. 11(a) and 11(b) are diagrams showing a state in which the system shown in FIG. 10 is further expanded;

FIG. 12 shows an example in which the system expansion according to the first embodiment of the invention is repeatedly performed;

FIG. 13 shows encryption/decryption keys that the receiver should calculate, when the system expansion according to the first embodiment of the invention is performed;

FIGS. 14(a) to 14(c) show examples of system expansion method according to a second embodiment of the invention;

FIG. 15 shows an example in which the system expansion according to the second embodiment of the invention is repeatedly performed;

FIG. 16 shows encryption/decryption keys that the receiver should calculate, when the system expansion according to the second embodiment of the invention is performed;

FIG. 17 is a diagram showing an information providing system to which the key management system according to the present invention is applied;

FIG. 18 is a block diagram showing a construction of a contents recording system according to an embodiment of the invention;

FIGS. 19(a) to 19(e) show contents of signals in the respective parts in the contents recording system shown in FIG. 18;

FIGS. 20(a) and 20(b) show contents of signals in the respective parts in the contents recording system shown in FIG. 18;

FIG. 21 is a block diagram showing a construction of a contents playback system according to an embodiment of the invention;

FIGS. 22(a) and 22(b) show contents of signals in the respective parts in the contents playback system shown in FIG. 21;

FIGS. 23(a) to 23(d) show contents of signals in the respective parts in the contents playback system shown in FIG. 21;

FIG. 24 is a flowchart showing a key information generation process;

FIG. 25 is a flowchart showing a system expansion process according to the first embodiment of the invention;

FIG. 26 is a flowchart showing a system expansion process according to the second embodiment of the invention;

FIG. 27 is a flowchart showing a process of assigning encryption keys to subsets;

FIG. 28 is a flowchart showing a process of assigning encryption/decryption keys to subsets in a case that the system is expanded by the system expansion method of the first embodiment;

FIG. 29 is a flowchart showing a process of assigning encryption/decryption keys to subsets in a case that the system is expanded by the system expansion method of the second embodiment;

FIG. 30 is a flowchart showing an encryption process of contents;

FIG. 31 is a flowchart showing a decryption process of contents; and

FIG. 32 is a flowchart showing a process of calculating decryption keys.

### DETAILED DESCRIPTION OF THE PREFERRED EMBODIMENTS

The preferred embodiments of the present invention will now be described below with reference to the attached drawings. First of all, a basic explanation is given as to a key management system, and then a key management system according to the embodiments of the present invention will be described.

(1.1) Key Management System with Receiver Revocation Function

In a system in which a transmitter or sender transmits identical data to a large number of receivers, there is a method in which a reliable key management center distributes confidential information to decrypt the transmitted information to all the receivers in advance, and the sender encrypts and transmits the information to the receivers so that the receivers who does not have the confidential information cannot decrypt the transmitted information. In this case, there is such a problem that, if all the receivers have the identical confidential information, once a malicious receiver publishes its confidential information, it becomes possible for any person to decrypt the information transmitted thereafter.

As a countermeasure to this problem, there is a method, i.e., a key management system having receiver revoking function, which disables the decryption of the transmitted information by using leaked confidential information when the key management center distributes different confidential information to the receivers and the confidential information of a certain receiver is leaked out. This invention deals with such a key management system.

Here, it is assumed such an application that the confidential information owned by the receivers can never be altered except for the initial assignment of the confidential information (decryption key, etc.) to the receivers.

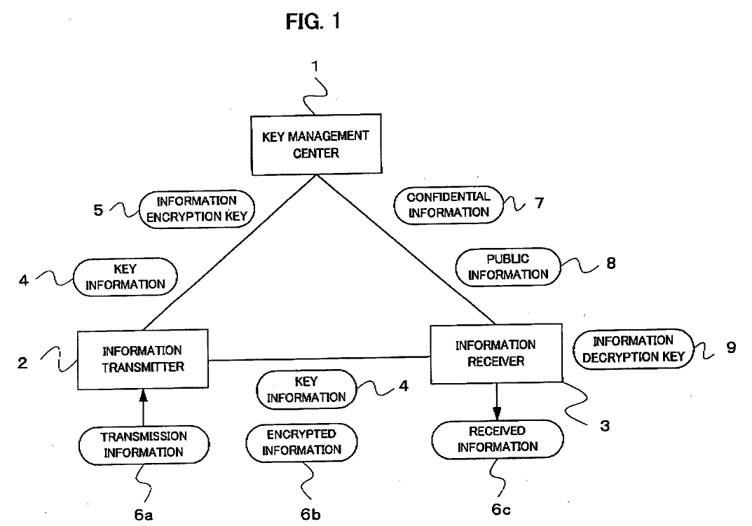

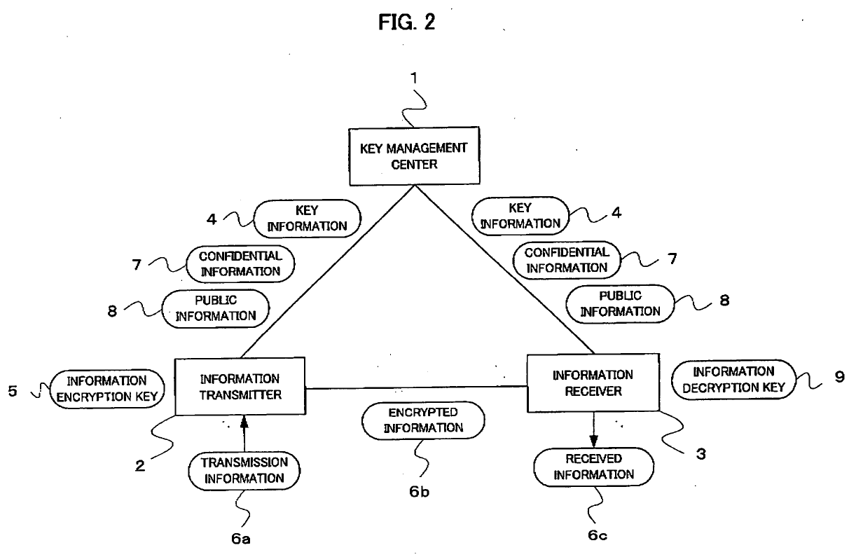

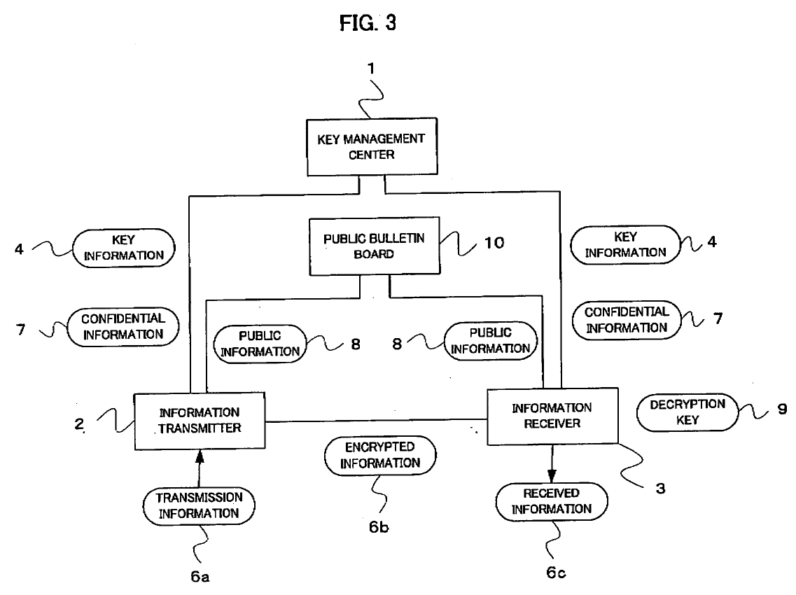

A model of an information providing system, to which the key management system having the receiver revoking function is applied, is shown in FIGS. 1 to 3. In FIGS. 1 and 2, the information providing system includes three constitutive elements, i.e., a key management center 1, an information transmitter 2 and an information receiver 3. On the other hand, the information providing system shown in FIG. 3 includes four constitutive elements, i.e., a key management center 1, an information transmitter 2, an information receiver 3 and a public bulletin board 10. The description will be given from FIG. 1 in order.

In FIG. 1, the key management center 1 assigns, to each information receiver 3, confidential information 7 and public information 8 for decrypting encrypted information 6b transmitted by the information transmitter 2. The public information 8 does not exist in a certain key management system, but the confidential information 7 necessarily exists. Also, the key management center 1 determines a set of receivers for which the decryption of the encrypted information 6b is disabled, generates key information 4 which the receivers other than the receivers belonging to the above set can decrypt, and transmits the key information 4 to the information transmitter 2 together with the key (information encrypting key 5) for encrypting the transmission information 6a. Hereinafter, disabling a certain receiver to decrypt the transmitted information is called “revocation of receiver”. It is assumed here that the generation, storage and transmission of the confidential information 7 assigned to the respective receivers and the key (information encrypting key 5) used to encrypt the transmission information 6a are performed safely.

The information transmitter 2 encrypts the transmission information 6a by using the information encryption key 5 transmitted from the key management center 1 to produce the encrypted information 6b, and transmits the encrypted information 6b to the receivers together with the key information 4 which can be decrypted only by the receivers who are not revoked (hereinafter referred to as “non-revoked receiver”).

When receiving the encrypted information 6b, the non-revoked receiver calculates the information decryption key 9 by using the confidential information 7 and the public information 8 that the receiver owns and the received key information 4, and decrypts the encrypted information 6b by using the information decryption key 9 to obtain the received information 6c. On the contrary, the receiver who is revoked (hereinafter referred to as “revoked receiver”) cannot obtain any information associated with the encrypted information 6b if plural revoked receivers collude with each other. Here, it is assumed that a large number of receivers exist.

In the information providing system shown in FIG. 2, the key management center 1 transmits only the key information 4 to the information transmitter 2, and does not transmit the information encryption key 5. In this case, like the information receiver 3, the information transmitter 2 calculates the information encryption key 5 from the confidential information 7 and the public information 8 received from the key management center 1. Therefore, the key management center 1 needs to assign the confidential information 7 and the public information 8 to the information transmitter 2.

In the information transmission system shown in FIG. 3, the public information 8 is not stored by the key management center 1, but stored in a public space such as a public bulletin board 10. Every time the information is encrypted or decrypted, the information transmitter 2 or the information receiver 3 accesses the public bulletin board 10 to download the public information 8.

Next, the constitutive elements described above will be described in detail.

It is assumed that N is a set of all receivers, and the number of its elements is |N|=N. It is also assumed that a subset R of N is a set of the receivers to be revoked, and the number of its elements is |R|=r. The goal of the key management system having the receiver revoking function is that the receivers permitted by the key management center (or the information transmitter), i.e., all the receivers u∈N\R who are not included in R can decrypt the transmitted information, and all the receivers included in N who are not permitted can obtain no transmitted information even if they collude with each other.

(a) Key Management Center

(i) Initial Setting

First, subsets S₁, S₂, . . . S_{w(}^{∀}j, Sⱼ⊂N) of the set N of all the receiver are defined. Each subset Sⱼ is assigned encryption (decryption) key Lⱼ. It is desired that each Lⱼ is assigned a uniformly distributed value independent of each other. To each of the receivers (the receiving apparatuses) u, confidential information SIᵤ and public information PIᵤ are assigned. It is necessary that the confidential information SIᵤ and the public information PIᵤ are assigned such that all the receivers u∈Sj included in Sⱼ can obtain the decryption key Lⱼ assigned to the subset Sⱼ to which it belongs, from the confidential information SIᵤ and the public information PIᵤ assigned to itself. In addition, the confidential information SIᵤ and the public information PIᵤ must be assigned such that all the receivers u∈N\Sⱼ who are not included in Sⱼ cannot obtain the decryption key Lⱼ even if they collude with each other.

(ii) Generating Key Information

(1) The key K used to encrypt and decrypt transmission information M (i.e., the above-mentioned information encryption key 5 or information decryption key 9, hereinafter referred to as “session key”) is selected.

(2) The receivers u∈N\R belonging to the complementary set N\R of the subset R are divided into some subsets Sᵢ₁, Sᵢ₂, . . . Sim.

$$\underline{N} \backslash \underline{R} = {⋃}_{i = 1}^{m} {\underline{S}}_{{i}_{j}} \qquad ( 1 \text{-} 1 )$$

It is assumed that the encryption/decryption keys assigned to the above subsets by the initial setting are Lᵢ₁, Lᵢ₂, . . . Lᵢₘ. Since Lᵢ₁, Lᵢ₂, . . . Lᵢₘ are the encryption keys for the information transmitter 2 to encrypt the session key, and are the decryption keys for the information receiver 3 to decrypt the session key, they are expressed as “encryption/decryption key”.

(3) The session key K is encrypted m times by using the encryption/decryption keys Lᵢ₁, Lᵢ₂, . . . Lᵢₘ and the following equation (1-2) is generated.
[i₁,i₂, . . . iₘ,E_{enc}(K,Lᵢ_{₁}),E_{enc}(K,Lᵢ_{₂}), . . . ,E_{enc}(K,Lᵢ_{ₘ})] (1-2)
The equation (1-2) is delivered to the information transmitter 2 together with the session key K. Here, i₁, i₂, . . . iₘ are index information by which each receiver uⱼ specifies the cipher text E_{enc}(K,Lᵢⱼ) to be decrypted and assigned to itself from the equation (1-2).

We assume that the delivery of the session key K to the information transmitter is securely carried out. Note that E_{enc} indicates the encryption algorithm. There are following two encryption, decryption algorithms used in this system (note that the completely same algorithm may be used as those two algorithms).
Encryption algorithm F_{enc} and Decryption algorithm F_{dec} of the transmission information M

Cipher text C_{K}=F_{enc}(M,K) is generated by using the session key K. Processing speed is required.
Encryption algorithm E_{enc} and Decryption algorithm E_{dec} of the session key K

They are used for the delivery of the session key. Higher security than F_{enc} is required.

It is noted that, if the session key is not delivered to the information transmitter 2, the confidential information and the public information are assigned to the information transmitter in the initial setting, like the information receiver, to enable the information transmitter to calculate the session key from those information and the key information.

(b) Information Transmitter

The information transmitter receives the session key K and the key information which can be decrypted only by permitted receivers from the key management center, encrypts the transmission information M using the encryption algorithm F_{enc} with the session key K, and transmits the cipher text [symbol]
[i₁,i₂, . . . iₘ,E_{enc}(K,Lᵢ_{₁}),E_{enc}(K,Lᵢ_{₂}), . . . ,E_{enc}(K,Lᵢ_{ₘ})],F_{enc}(M,K) [symbol] (1-3)
The portion in square brackets [ ] in the above equation (1-3) is called “header” of F_{enc}(M,K)

(c) Information Receiver

The information receiver u receives the following cipher text encrypted by the information transmitter. [symbol]
[i₁,i₂, . . . iₘ,C_{L,}_{₁},C_{L,}_{₂} . . . ,C_{L,}_{ₘ}],C_{K} [symbol] (1-4)
Then, the receiver operates as follows:

(1) Find iⱼ which satisfies u∈Sᵢⱼ (in case u∈R the result is null).

(2) Calculate Lᵢⱼ from the confidential information S1ᵤ and the public information PIᵤ that the receiver has.

(3) Calculate K=E_{dec}(Cᵢⱼ,Lᵢⱼ).

(4) Calculate M=F_{dec}(C_{K},K).

There are following algorithms which can implement the above key management system:
The Complete Sub-tree Method
The Subset Difference Method
Tree Pattern Division Method

The above methods are different in (1) the definition of the subsets S₁, . . . , S_{w} of the receivers, (2) the method of assigning the encryption (decryption) keys L_{Sj} and the public information PI to the subsets, (3) the method of dividing the set N\R the receivers non-revoked, (4) the method of assigning SIᵤ and PIᵤ to each receiver u, and (5) the method of obtaining the key L_{Sj} assigned to the subset Sⱼ to which the receiver belongs, from SIᵤ and PIᵤ.

Those algorithms are evaluated in view of following four aspects.
Amount of key information to be transmitted

It corresponds to the portion “[ ]” in the equations (1-2) and (1-3), and it is transmission information necessary to decrypt the cipher text F_{enc}(M,K). Generally, it is proportional to the number m of the subsets obtained by dividing N\R.
Amount of confidential information SIᵤ that the receiver stores

Namely, how much confidential information such as decryption key and the like does a receiver need to store.
Amount of public information PIᵤ that the receiver stores

Namely, how much public information to obtain the decryption key does a receiver need to store.
of arithmetic operation necessary for the receiver to decrypt the transmitted information
   (1.2) Basic Method

As a basic method of the embodiment of the invention, the key management system used in the Three Pattern Division, Master Key Method and the like will be described.

(1.2.1) Definition of Subsets S₁, S₂, . . . S_{w}

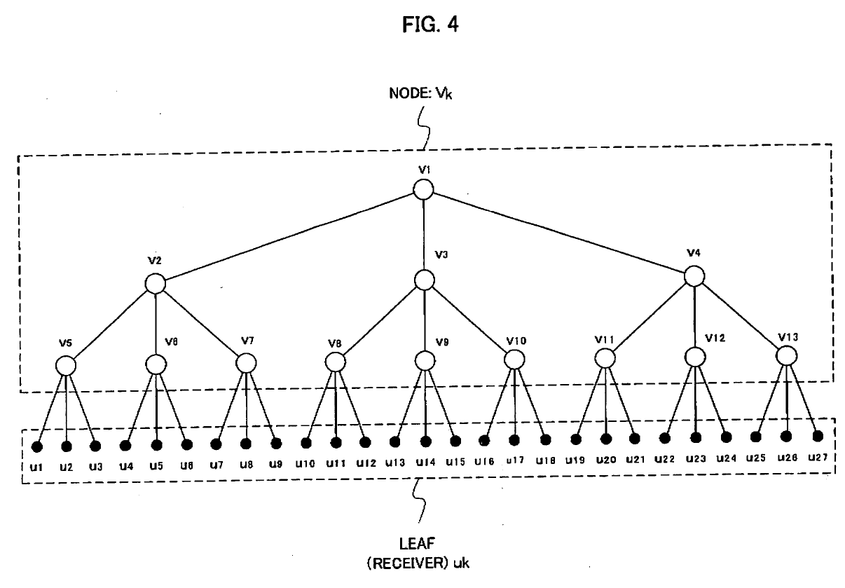

First, the subsets S₁, S₂, . . . S_{w} of the set N of the whole receivers is defined. To the subsets, the encryption/decryption keys Lᵢ₁, Lᵢ₂, . . . Lᵢₘ are assigned. Each receiver uⱼ (j=1, 2, . . . N) is assigned to the leaf of a-ary having N leaves (here, “a” satisfies a>1, and N is a power of “a”). FIG. 4 shows an example of the case in which a=3, N=27.

Each internal nodes of the a-ary tree is numbered as vₖ (k=1, 2, . . . , (N−1)/(a−1)). Note that the root is numbered as v₁, and the numbering of the nodes is made in an order from the upper layer to the lower layer, and from the left side to the right side, as shown in FIG. 4. The receivers uⱼ (j=1, 2, . . . , N) assigned to the leaves are also numbered in an order from the left side to the right side.

Next, 2^{a}-2 subsets S_{k,b1b2 . . . bi . . . ba} are defined for all the internal nodes vₖ (k=1, 2, . . . , (N−1)/(a−1)). Here, “bi” satisfies the following equation (2-1)
bᵢ∈{0,1},Σᵢ₌₁^{a}bᵢ≠0,Σᵢ₌₁^{a}bᵢ≠a (2-1)

The subsets S_{k,b1b2 . . . bi . . . ba} are defined as the set of the receivers assigned to the descendant leaves of the child nodes for which bᵢ=1 if the “a” child nodes of the nodes vₖ are defined as b₁, b₂, . . . , bᵢ, . . . bₐ, in an order from left side to right side. Namely, if a leaf, to which the receiver to be revoked is assigned, exists at the descendant of the “a” child nodes of the node vₖ, bᵢ corresponding to the child node satisfies bᵢ=0. In this case, the child node satisfying b₁=0 is called “revoked node”. Whether or not the “a” child nodes of the node vₖ is the revoked node is indicated by the value bi∈{0,1}. Those values arranged from the left side in an order of b₁, b₂, . . . , bᵢ, . . . bₐ is called “node revocation pattern”.

For example, in the case that a=3, N=27 shown in FIG. 4, the subsets defined to the root node (also simply referred to as “root”) v₁ are S_{1,100}, S_{1,010}, S_{1,001}, S_{1,110}, S_{1,101}, S_{1,011}, S_{1,111}, and the subsets defined to the node v₂ . . . v_{(N-1)(a-1)} are S_{k,100}, S_{k,010}, S_{k,001}, S_{k,110}, S_{k,101}, S_{k,011}. At this time, as the set including all the receivers, the set S_{1,11 . . . 1} is defined for the root node of a-ary tree. The subset S_{2,101} is a subset constituted by the receivers u₁, u₂, u₃, u₇, u₈, u₉ assigned to the descendant leaves of the nodes v₅, v₇, corresponding to b₁ and b₃, in the child nodes v₅, v₆, v₇ of the node v₂.

(1.2.2) Method of Assigning Encryption/Decryption Keys L_{k,b1b2 . . . ba} to Each Subset S_{k,b1b2 . . . ba}

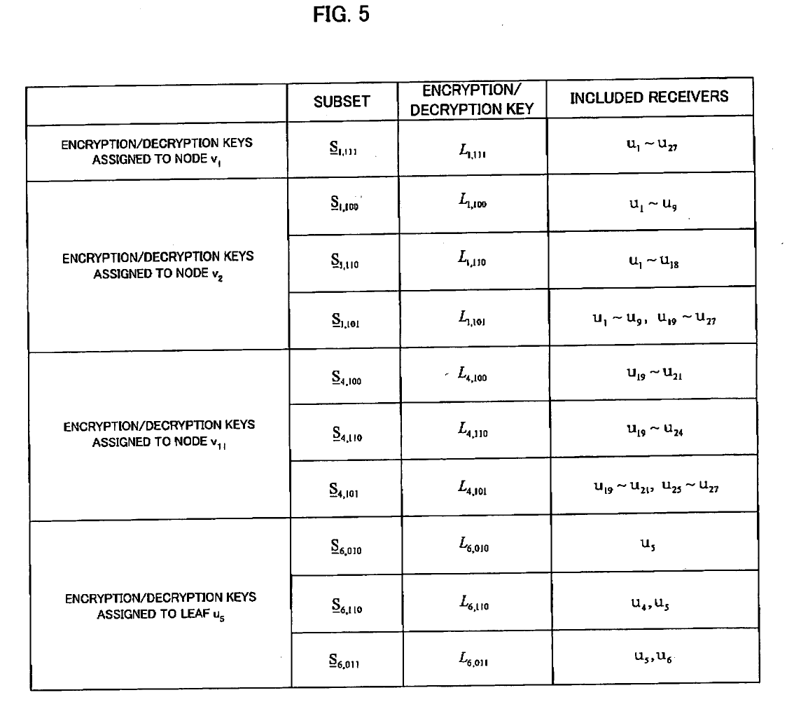

The key management center assigns the encryption/decryption keys L_{k,b1b2 . . . ba} each having independent values to the subsets S_{k,b1b2 . . . ba}. FIG. 5 shows examples of the subsets, the encryption/decryption keys and the receivers included in the subsets, which are assigned to some nodes and leaves in the case that a=3 and N=27.

(1.2.3) Method of Assigning SIᵤ to Each Receiver u, and Calculation Method of Encryption/Decryption Keys L_{k,b1b2 . . . ba} from SIᵤ

The key management center directly gives the receiver u, the encryption/decryption keys L_{k,b1b1 . . . ba}, as the confidential information Piᵤ. These keys are assigned to the subsets including the receiver u as its element, out of the subsets S_{k,b1b2 . . . ba} defined to the nodes vₖ existing on the path from the leaf to which the receiver u is assigned to the root. The number of encryption/decryption keys L_{k,b1b2 . . . bm} stored in the receiver u₂₀ is shown in the following equation (2-2)
(2^{a-1}−1)logₐN+1 (2-2)
For example in the case that a=3 and N=27, the description of the confidential information SIᵤ₂₀ stored in the receiver u₂₀. The subsets in which the receiver u₂₀ is included are S_{1,111}, S_{1,001}, S_{1,101}, S_{1,011}, S_{4,100}, S_{4,110}, S_{4,101}, S_{11,010}, S_{11,110} and S_{11,011}. The confidential information SIᵤ₂₀ corresponding to those subsets are L_{1,111}, L_{1,001}, L_{1,101}, L_{1,011}, L_{4,100}, L_{4,110}, L_{4,101}, L_{11,010}, L_{11,110} and L_{11,011}. These information (encryption/decryption keys) are stored in the receiver u₂₀.
(1.2.4) Dividing Method of N\R (Set of Non-Revoked Receivers)

This section describes the method that divide the set N\R to the above defined subset. Here, the set N\R include receivers permitted to receive information (set of non-revoked receivers). First, the key management center sets all the internal nodes, existing on the path from the leaf corresponding to the receiver to be revoked to the root, to the revoked nodes. If there is no receiver to be revoked, the set S_{1,11 . . . 1} is made N\R. When the revoked node is vₖ, except for the case that all the child nodes of vₖ are revoked nodes, the subset S_{k,b1b2 . . . ba} (bᵢ satisfies the equation (2-1)) defined to the vₖ is chosen as the subset constituting the set N\R of the receiver. Here, it is necessary that a pattern corresponding to the actual revoked child nodes is chosen as the node revocation pattern b₁b₂ . . . bᵢ . . . bₐ. Thus, one subset is chosen for the above revoked node. The above process is carried out for all the revoked nodes, and the chosen subsets constitute the set N\R. The upper limit of the number of the chosen subsets is given as: r(logₐN/r+1) when the number of the receivers to be revoked is expressed as: |R|=r. be revoked are u₃, u₇, u₈, u₁₀, u₁₁, u₁₂, u₁₆ (the reference numeral 30 shows the receivers who are not revoked) in the case that a=3 and N=27. In this case, the revoked nodes are v₁, v₂, v₃, v₅, v₇, v₈, v₁₀, and the revoked nodes for which all of the child nodes are not the revoked node are v₁, v₂, v₃, v₅, v₇, v₁₀. Therefore, the subsets constituting N\R are S_{1,001}, S_{2,010}, S_{3,010}, S_{5,110}, S_{7,001}, S_{10,011}.

(1.3) Key Management System of Embodiment

The key management system according to an embodiment of the invention, will be described. Since the definition of the subsets S₁, S₂, . . . S_{w}, and the method of dividing the set N\R of the receivers are the same as those in the above-described basic method, the description thereof will be omitted.

(1.3.1) Method of Assigning Encryption/Decryption Keys L_{k,b1b2 . . . ba} and Public Information PI to Each Subset S_{k,b1b2 . . . ba}

The key management center chooses two large prime numbers q₁ and q₂ (e.g., not smaller than 512 bits), publishes the product M of q₁ and q₂ as the public information. Each of the prime numbers q₁ and q₂ is confidentially stored in the key management center.

Next, the key management center chooses 2^{a}-2 natural numbers p_{b1b2 . . . ba} (e.g., prime numbers) relatively prime and satisfying the equation (3-1). Here, bᵢ satisfies the equation (2-1).
gcd(λ(M),p_{b}_{₁}_{b}_{₂}_{. . . b}_{ₐ})=1 (3-1)
Hereinafter, the 2^{a}-2 indexes b₁b₂ . . . bₐ are expressed as “B” “λ(M)” is called as Carmichael function and is given by the equation (3-2):

$$λ ( M ) = \frac{( {q}_{1} - 1 ) ( {q}_{2} - 1 )}{gcd ( {q}_{1} - 1 , {q}_{2} - 1 )} \qquad ( 3 \text{-} 2 )$$

The key management center assigns the prime number p_{B} to the subsets S_{k,B}, and publishes each p_{B} and the assignment as the public information PI. Also, “E” is determined as the product of all the prime numbers p_{B} assigned to all the subsets S_{k,B} defined to the node vₖ. Namely,
E=p_{00 . . . 001}p_{00 . . . 010}p_{00 . . . 011} . . . p_{11 . . . 100} . . . p_{11 . . . 001}p_{11 . . . 110}.
   The key management center chooses gᵢ∈Z*_{M} at random, and determines the encryption/decryption keys L_{l,B} assigned to the 2^{a}-2 subsets S_{l,B} defined to the node vₖ as the equation (3-3):
   L_{l,B}=g₁^{E/p}^{ₐ}mod M (3-3)
   Here, Z*_{M} is a set of residue class rings Z_{M}={0, 1, . . . , M−1} which has a positive integer M as a modulus and which is relatively prime to M. This is called “irreducible residue class”, and forms group in respect of multiplication. Also, “g₁” is confidentially stored by the key management center.

For the set S_{1,11 . . . 1} including all the receivers, the encryption/decryption keys L_{1,11 . . . 1} to be assigned are determined as follows:
L_{1,11 . . . 1}=g₁^{E}mod M (3-4)
Here, in the subsets defined to an arbitrary internal node vₖ, the following index set is defined for each of the “a” child nodes vⱼ which are child nodes of vₖ. The set of the indexes B of the subsets S_{k,B} including the receivers assigned to the descendant leaves of vⱼ is defined as the index set ALⱼ. Next, for each of the child nodes vⱼ, the master keys given by the equation (3-5) is defined:

$$\begin{matrix}{MK}_{k , j} = g \text{?} mod M \\ = g \text{?} mod M\end{matrix} \\ \text{?} \text{indicates text missing or illegible when filed} \qquad ( 3 \text{-} 5 )$$

From the master keys defined by the equation (3-5), the encryption/decryption keys assigned to the subsets S_{k,i}(i∈ALⱼ) having the indexes included in the index set ALⱼ, out of the subsets S_{k,B} defined to the node vₖ, can be calculated as shown in the equation (3-6):
L_{k,i}=(MK_{k,j})^{ΠAL}^{ⱼ}^{p}^{/p}mod M (3-6)

However, for the subsets S_{k,i} (i∈ALⱼ) having the indexes not included in the index set ALⱼ, it is difficult to obtain the pᵢ-th power root of the master key MK_{k,j}, and hence the encryption/decryption keys L_{k,i} (i∈ALⱼ) cannot be obtained.

Next, let us consider the encryption/decryption keys L_{4,a} assigned to the 2^{a}-2 subsets S_{4,a} defined to the node V₄ which is the child node v₄ of v₁, in the case of the tree structure in which a=3 and N=27 as shown in FIG. 4. First, MK_{1,4} defined by the equation (3-7) is calculated for the child node v₄.

$$\begin{matrix}{MK}_{1 , 4} = g \text{?} mod M \\ = g \text{?} mod M\end{matrix} \\ \text{?} \text{indicates text missing or illegible when filed} \qquad ( 3 \text{-} 7 )$$

Similarly to the node v₁, the encryption/decryption keys L_{4,B} assigned to the 2^{a}-2 subsets S_{4,B} defined to the child node v₄ are determined as the equation (3-8):
L_{4,B}=g₄^{E/p}^{ₐ}mod M (3-8)
Here, g₄ is defined by the equation (3-9):
MK_{1,4}=PRP(g₄^{E}) (3-9)

Pseudo Random Permutation (PRP) is a bijective function having an input and an output of integer not smaller than 0 and smaller than M. However, a power residue function having modulus of M cannot be used as the PRP. This PRP is opened to all the receivers. Hereinafter, “PRP⁻¹” is used as the inverse function of PRP.

The key management center calculates g₄^{E} from MK_{1,4} using PRP⁻¹, and then calculates E-th power root of g₄^{E} to obtain q₄. Since the key management center owns the prime factors q₁, q₂ of the modulus M, λ(M) in the equation (3-2) can be obtained. When λ(M) is obtained, a multiplicative inverse element D of E having λ(M) as the modulus is obtained by Euclidean algorithm, and the equation (3-10) can be calculated:
g₄=PRP⁻¹(MK_{1,4})^{D} (3-10)

In the above description, PRP is used when MK is calculated from g, and PRP⁻¹ is used when g is calculated from MK. Alternatively, PRP⁻¹ may bemused to calculate MK from g, and PRP may be used to calculate g from MK.

For g₄ thus calculated, by the same method as performed for the node vₗ, the encryption/decryption keys L_{4,B} can be assigned to the subsets S_{4,B} defined to the node v₄ as shown in the equation (3-8).

Thereafter, for all the internal nodes vₖ (k=1, 2, . . . , (N−1/(a−1)), the encryption/decryption keys L_{k,B} are assigned to the subsets S_{k,a} defined to the node vₖ in the same manner.

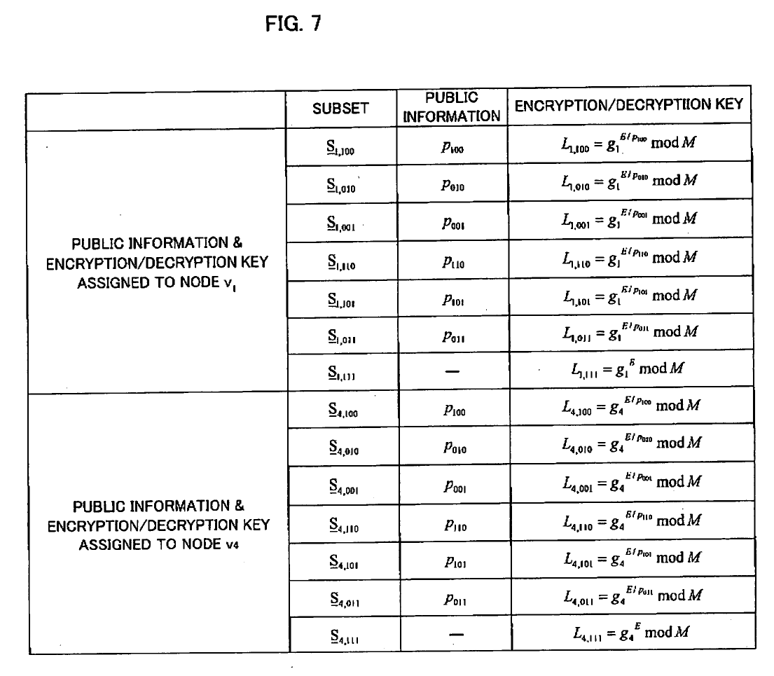

For example, FIG. 7 shows, the assignment of the encryption/decryption keys L_{I,B} and L_{4,B} to the subsets S_{1,B} and S_{4,a} defined to the nodes v₁ and v₄, in the case that a=3 and N=27.

In the above-described method, the prime number is not assigned, as the public information, to the subsets S_{1,11 . . . 1} including all the receivers. This aims to reduce the amount of the public information (number of prime numbers). However, the prime number may be assigned to the subsets S_{1,11 . . . 1} including all the receivers. If the prime number p_{1,11 . . . 1} is assigned, the encryption/decryption key L_{1,11 . . . 1} to be assigned is given by the equation (3-11):
L_{1,11 . . . 1}=g₁^{E/p}^{_{11 . . . 1}}mod M (3-11)

There is no problem if this case is considered that, for arbitrary internal nodes vᵢ, the prime numbers p_{i,11 . . . 1} are assigned, as the public information, to the subsets S_{i,11 . . . 1} including the receivers assigned to all the leaves existing under vᵢ. In this case, the encryption/decryption keys assigned to the subsets S_{i,11 . . . 1} are given as follows.
L_{1,11 . . . 1}=g₁^{E/p}^{_{11 . . . 1}}mod M (3-12)

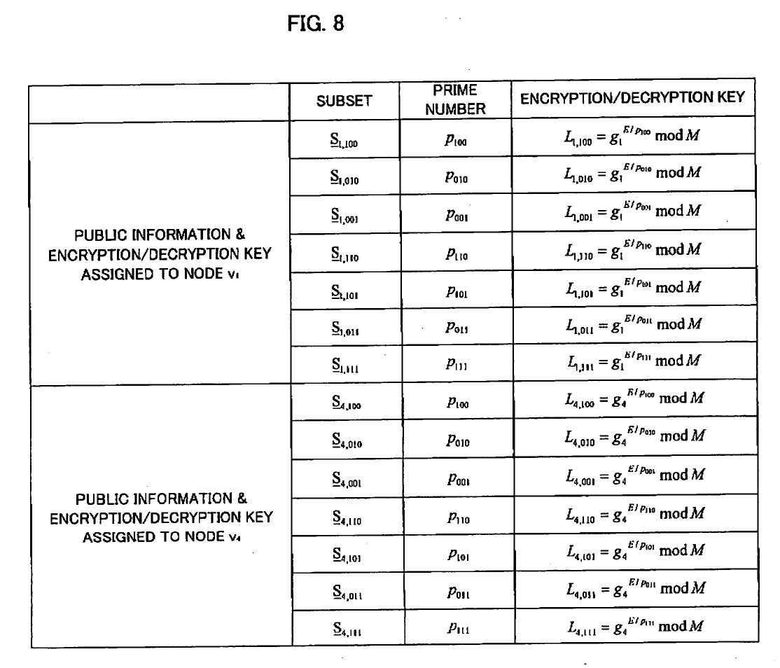

FIG. 8 shows an example of assigning the encryption/decryption keys to the subsets defined for v₁ and v₄ in the case that a=3 and N=27. When the above assignment is performed, the subsets S_{i,11 . . . 1} constituted by the receivers assigned to all the leaves existing under the arbitrary internal node vᵢ are doubly defined. This is because the subsets defined to each of the internal nodes increases from 2^{a}-2 to 2^{a}-1. For example, the subsets S_{1,001} and the subsets S_{4,111} in FIG. 8 are both constituted by the receivers u₁₉ to u₂₇, and the encryption/decryption keys L_{1,001} and L_{4,111} assigned to the respective subsets have the relationship shown by the equation (3-13). In this case, either value may be used.

$$\begin{matrix}{L}_{1 , 001} = MK \text{?} mod M \\ = PRP ( {L}_{4 , 111} ) \text{?} mod M\end{matrix} \\ \text{?} \text{indicates text missing or illegible when filed} \qquad ( 3 \text{-} 13 )$$

(1.3.2) Method of Assigning SIᵤ and PIᵤ to Each Receiver u, and Calculation Method, Encryption/Decryption Keys L_{k,B} from SIᵤ and PIᵤ

The key management center gives 2^{a}-2 prime numbers p_{b1b2 . . . ba} to the receiver u as the public information. Here, bᵢ satisfies the above-mentioned equation (2-1).

Further, to the parent node vk_{logaN} of the receiver u, the master keys defined by the equation (3-5) are assigned to the receiver u as the confidential information SIᵤ. If the leaf to which the receiver u is assigned is vk_{logaN+1}, the confidential information stored in the receiver u is given by the equation (3-14):

$$\begin{matrix}{SI}_{w} = MK \text{?} = g \text{?} mod M \\ = g \text{?} mod M\end{matrix} \\ \text{?} \text{indicates text missing or illegible when filed} \qquad ( 3 \text{-} 14 )$$

In the subset Sk_{logaN,B} defined to the node vk_{logaN}, the subset including the receiver u is the subset Sk_{logaN,1} (1∈ALk_{logaN+1}) having the index included in the index set ALk_{logaN+1}. The encryption/decryption keys Lk_{logaN,1} (1∈ALk_{logaN+1}) assigned to the subsets Sk_{logaN,1} (1∈ALk_{logaN+1}) can be calculated by the method indicated by the equation (3-6).

Next, the master keys MKk_{logaN-1}, k_{logaN} defined to the parent node vk_{logaN-1} of the node vk_{logaN} is calculated by the equation (3-15):

$$\begin{matrix}MK \text{?} = PRP ( MK \text{?} mod M ) \\ = PRP ( g \text{?} mod M ) \\ = g \text{?} mod M\end{matrix} \\ \text{?} \text{indicates text missing or illegible when filed} \qquad ( 3 \text{-} 15 )$$

Similarly to the case of the node vk_{logaN}, out of the subsets Sk_{logaN-1,B} defined to the node vk_{logaN-1}, the encryption/decryption keys Lk_{logaN-1,1} (1∈ALk_{logaN}) assigned to the subsets Sk_{logaN-1,1} (1∈ALk_{logaN,B}) including the receiver u can be calculated by the method indicated by the equation (3-6).

By repeating the same process up to the root node v₁, the encryption/decryption keys assigned to all the subsets including the receiver u can be obtained. Finally, the encryption/decryption keys L_{1,11 . . . 1} assigned to the subsets S_{1,11 . . . 1} including all the receivers can be obtained by the calculation of the equation (3-16):
L_{1,11 . . . 1}=MK_{1,k}^{Π}^{_{ALp}}^{₁}mod M (3-16)

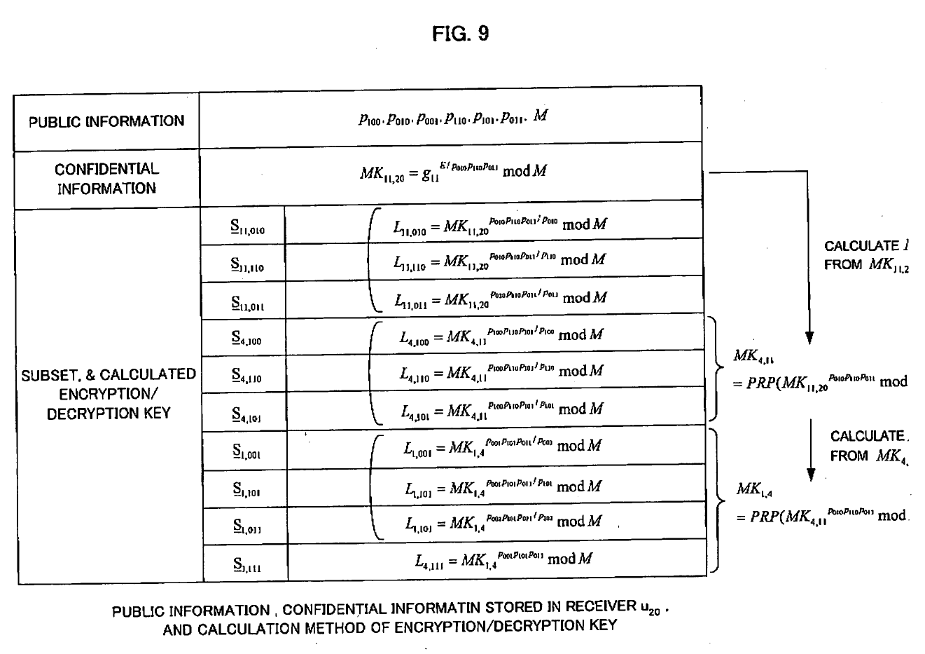

For example, FIG. 9 shows the confidential information SIᵤ₂₀ and the public information stored in the receiver u₂₀, as well as the calculation method of the encryption/decryption keys from them, in the case that a=3 and N=27. The master key MK_{4,11} assigned to the node v₁₁ is calculated from the confidential information MK_{11,20} assigned to the receiver u₂₀, and the master key MK_{1,4} assigned to the node v₄ is calculated from the master key MK_{4,11}. Then, the encryption/decryption key is obtained from the master keys MK_{11,20}, MK_{4,11} and MK_{1,4}.

(1.3.3) Effect

In the key management system according to the embodiment of the invention, similarly to the key management system described in the Document-1, the amount of the confidential information stored in the receiver does not depend on the total number N of the receivers. Therefore, only one (1024 bits) confidential information is sufficient even if the total number N of the receivers is large. Although the second basic method requires large number of confidential information (prime numbers) stored in the receiver, the key management system according to the first embodiment requires 2^{a}-2, i.e., less number of public information. Therefore, the number of public information (prime numbers) used by the whole system is small, and hence the key management system can easily generate and manage them.

The key management system according to the first embodiment employs the system in which all the master keys, defined to the nodes existing on the path from the leaf to which the receiver is assigned to the root can be obtained, in sequence, from the master keys defined to the nodes at the lower layers. In addition, the relationship between the encryption/decryption keys assigned to the subsets respectively defined to two nodes in a parent-child relationship are set to uncorrelated values by using the bijective function PRP. Thus, the assignment of the encryption/decryption keys using the master keys can be carried out independently between plural nodes, and hence the amount of the public information (number of the prime numbers) can be remarkably reduced.

(2.1) System Expansion Method of First Embodiment

The system expansion method according to a first embodiment of the invention will be described below. Here, the description will be given of a key management system in which the receiver can be added without upper limit to expand the system. As the basic algorithm, the key management system described in (1.3) is used. The system can be expanded mainly by the key management center.

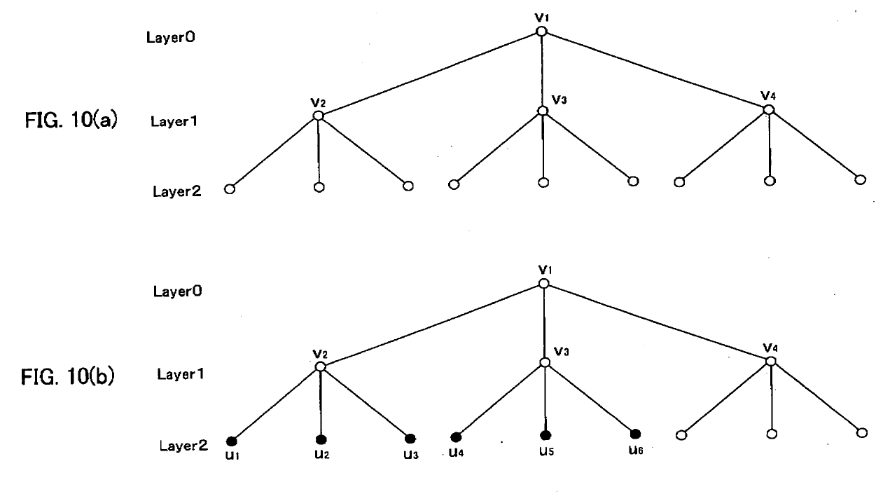

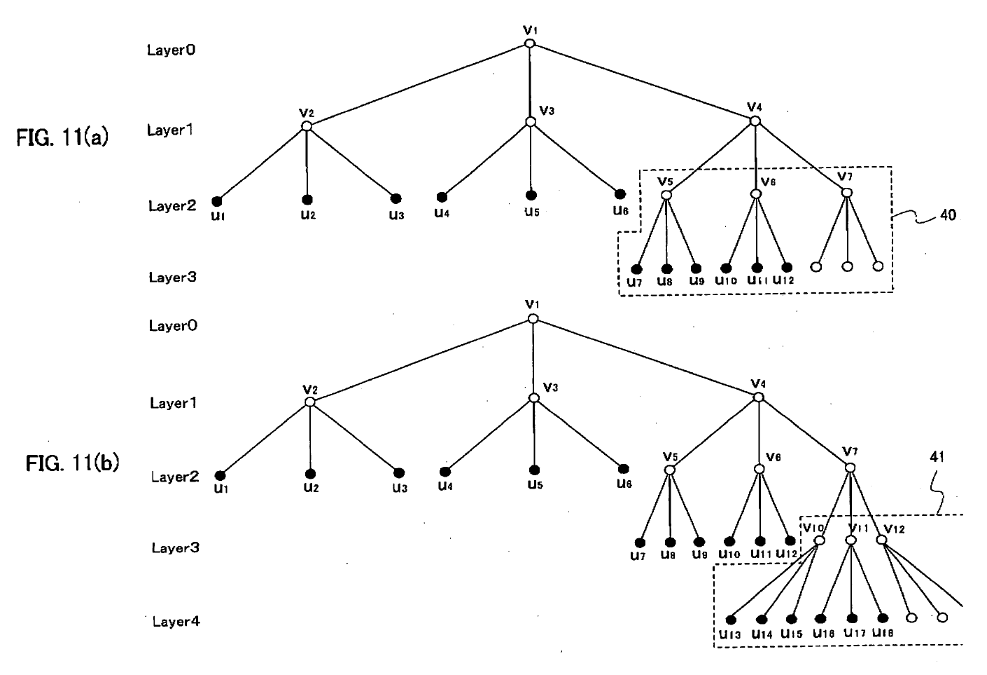

First, specific examples of an expansion method of the tree structure according to the first embodiment will be described with reference to FIGS. 10 and 11.

As shown in FIG. 10(a), it is assumed that there is a tree whose division number “a”=3 and which has three layers. Here, the layer at which the root node exists is defined as “Layer0”, the layer at which the child nodes of the root node exist is defined as “Layer1”, and the layer at which the grandchild nodes exist is defined as “Layer2”. No receiver has been assigned to the leaf of this tree yet. In order to determine whether or not the tree should be expanded, a threshold value “3” is used below. The tree shown in FIG. 10(a) has 9 leaves to which no receiver is assigned. Since the number is larger than the threshold value, the tree is not expanded.

FIG. 10(b) shows the tree after the receivers u₁ to u₆ are assigned. As shown, the receivers are assigned to the leaves in the order from the left side to the right side of the figure.

When the assignment of the receivers is completed, the number of the leaves to which no receiver is assigned becomes “3”. This number is not larger than the threshold value “3”, and hence the tree is expanded. The expanded tree is shown in FIG. 11(a). As shown, a new layer Layer3 is generated, and the tree is expanded (section of the reference numeral 40). As shown, 9 child nodes are generated from the nodes v₅, v₆, v₇, respectively. When new receivers u₇ to u₁₂ are assigned, those receivers are assigned by using the child nodes thus generated as the leaves.

When the receivers u₇ to u₁₂ are assigned as described above, the number of the leaves to which no receiver is assigned becomes “3”. Therefore, as shown in FIG. 11(b), a new layer Layer4 is generated, and the tree is expanded (section of the reference numeral 41). As shown, 9 child nodes are generated from the nodes v₁₀, v₁₁, v₁₂, respectively. And new receivers u₁₃ to u₁₈ are assigned to these generated nodes.

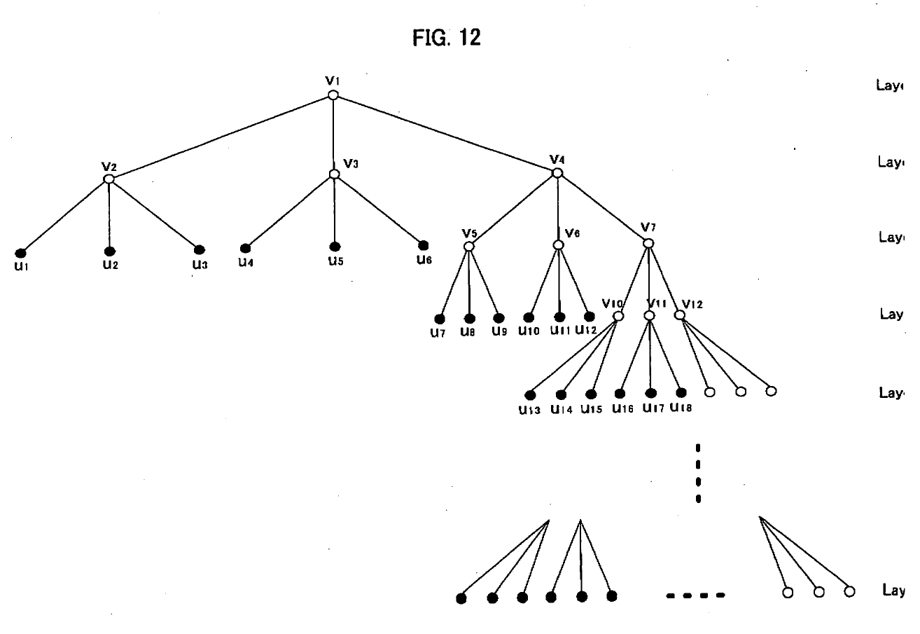

In this manner, according to the system expansion method of the first embodiment, when new receivers are assigned, the tree is expanded if the number of the leaves to which no receiver is assigned is not larger than the threshold value. As shown in FIG. 12, the new layers are sequentially generated as described above, the receivers can be infinitely added to this system. As illustrated, the layers of the receivers are different.

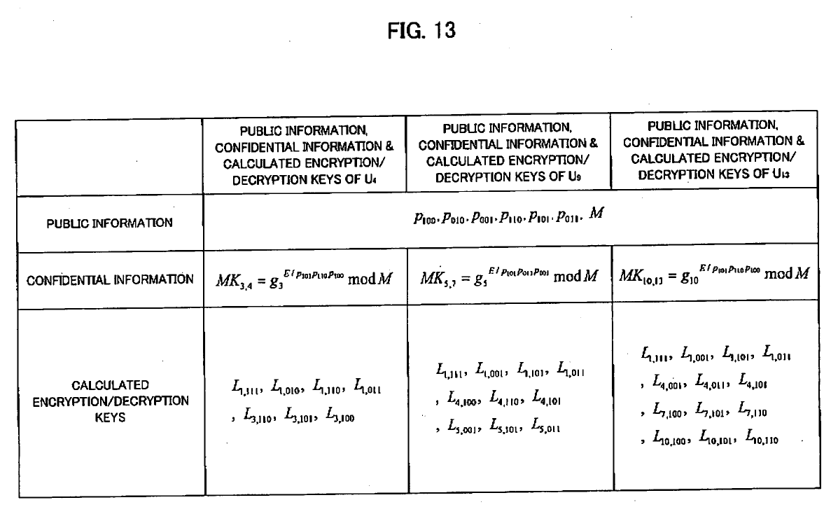

Next, the public information stored in the receiver, the confidential information stored in the receiver, and the calculated encryption/decryption key calculated in the above-described specific example are shown in FIG. 13. FIG. 13 shows the case of the receivers u₄, u₉, u₁₃ as the example. The above-described key management system of the embodiment is used here, the receivers store common public information. It is sufficient that the receiver stores one information as the confidential information. Further, the receiver calculates the encryption/decryption key shown at the bottom row in FIG. 13 by using the public information and the confidential information. The encryption/decryption keys can be calculated from the master keys defined to the nodes existing on the path from the leaf to which the receiver is assigned to the root. Therefore, there is no difference between the information amount to be stored in the receivers dependently upon the position of the layer to which the receiver belongs. Namely, it is possible to avoid such a situation that the receiver added lately should store much information than the receiver added early.

Further, according to the system expansion method of the first embodiment, the tree can be readily expanded according to the number of the receivers to be newly added. Therefore, the number of the nodes included in the tree can be minimized by expanding the tree according to the increase of the receivers, and hence the key management center can reduce the computational amount at the time of assigning the master keys and the encryption/decryption keys. Thereby, this expansion method is effective when the number of the receivers to be newly added is relatively small.

(2.2) System Expansion Method of Second Embodiment

Next, the system expansion method according to the second embodiment will be described. Here, the description will be given of the key management system in which the receiver can be added without upper limit to expand the system. As the basic algorithm, the key management system described in (1.3) is used. The system is expanded mainly by the key management center.

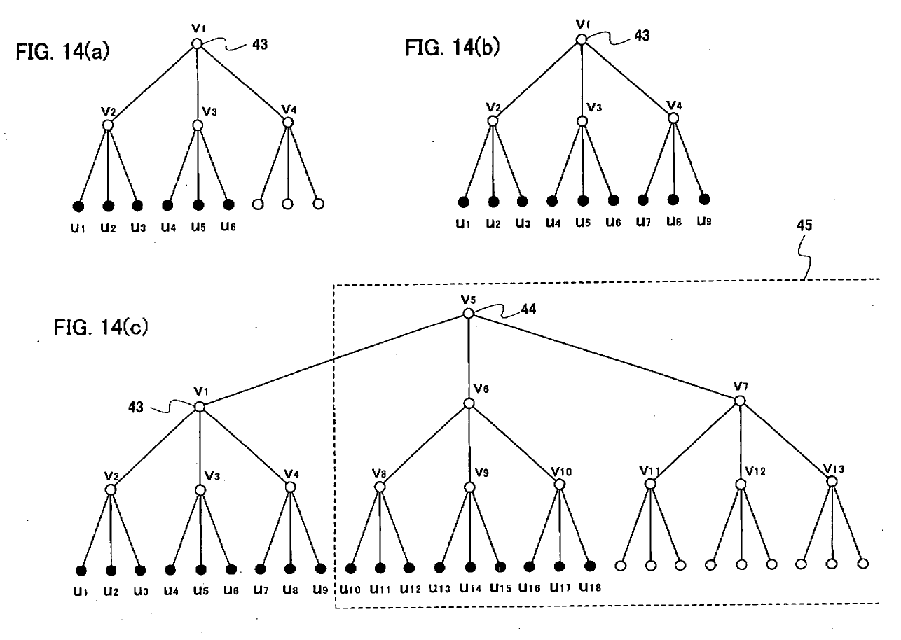

A specific example of the expansion method of the tree structure according to the second embodiment will be described with reference to FIG. 14. As shown in FIG. 14(a), it is assumed that there is a tree whose division number a=3 and which has three layers. The receivers u₁ to u₆ have already been assigned to this tree. FIG. 14(b) shows the situation wherein new receivers u₇ to u₉ are assigned to the tree shown in FIG. 14(a).

Next, let us think assigning new receivers to the tree of the situation shown in FIG. 14(b). Since there is no leaf to which no receiver is assigned in the tree, the tree is expanded to generate new leaves. This is shown in FIG. 14(c). As shown, the node v₁ (shown by the reference numeral 43) which has been the root node becomes the child node, and the tree having the new node v₅ (shown by the reference numeral 44) as the root node is generated. Thereby, the tree is expanded by the area indicated by the reference numeral 45. Here, when the tree used for the key management is “a”-divided tree, there are “a” patterns to set the root node before the expansion as a child node, and any pattern may be used. In the example of FIG. 14(c), the leftmost pattern is selected from the three patterns (i.e., the leftmost pattern, the center pattern and the rightmost pattern). The nodes having v₅ as the parent node are v₁, v₆, v₇. The v₆ is the parent node of v₈, v₉, v₁₀, and the v₇ is the parent node of v₁₁, v₁₂, v₁₃. Under those nodes v₈ to v₁₃, new leaves are generated. FIG. 14(c) shows the example in which new receivers u₁₀ to u₁₈ are assigned to the newly generated leaves.

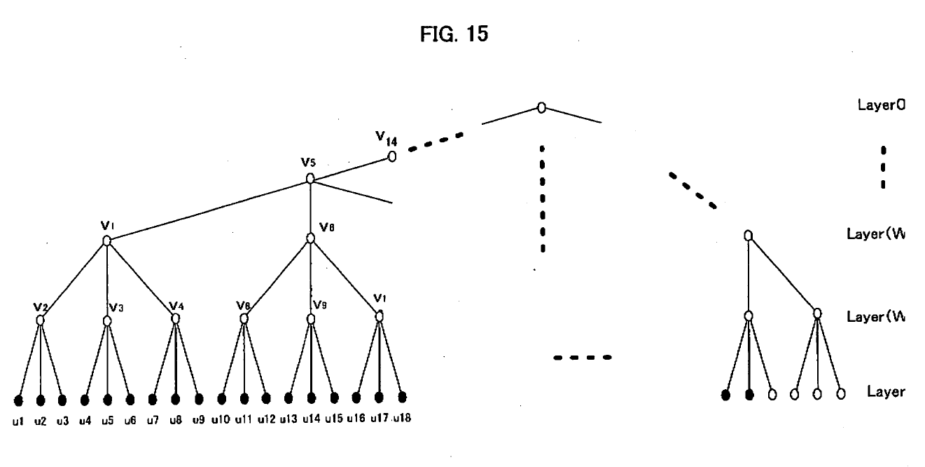

As described above, in the system expansion method of the second embodiment, when new receivers are assigned, the tree is expanded if there is no leaf to which no receiver is assigned. As shown in FIG. 15, the key management system can infinitely assign the receivers to the system. In the system expansion method of the second embodiment, all the receivers are included in the same layer, which is the lowest layer of the tree.

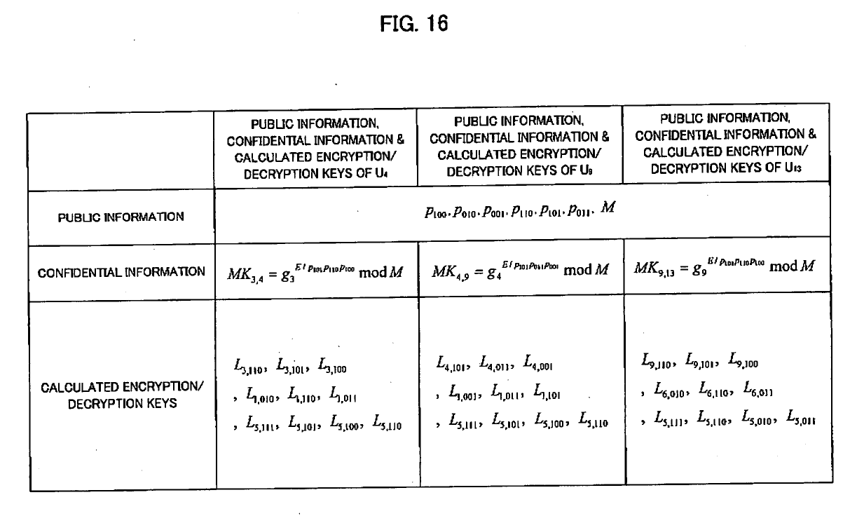

The public information stored in the receiver, the confidential information stored in the receiver, and the calculated encryption/decryption keys are shown in FIG. 16. FIG. 16 shows the case of the receivers u₄, u₉, u₁₃ as the example. The above-described key management system of the embodiment is used here, the receivers store common public information. It is sufficient that the receiver stores one information as the confidential information. Also in the system expansion method of the second embodiment, there is no difference between the information amount to be stored in the receiver added lately and the receiver added early.

In addition, the receiver calculates the encryption/decryption keys shown at the bottom row of FIG. 16 from those public information and the confidential information. The encryption/decryption keys can be calculated from the master keys defined to the nodes existing on the path from the leaf to which the receiver is assigned to the root. While the system expansion method of the first embodiment generates new leaves in the direction to lower layers, the system expansion method of the second method generates the leaves in the horizontal direction by generating a new root node. Therefore, in the system expansion method of the first embodiment, the computational amount to calculate the encryption/decryption key is larger for the receivers added lately than for the receivers added early. On the contrary, since the position of the layer to which all the receiver belong are the same in the system expansion method of the second embodiment, the number of the encryption/decryption keys to be calculated are the same for all the receivers. Therefore, the computational amount to calculate the encryption/decryption keys are not different.

The system expansion methods of the first embodiment and the second embodiment can be used, in combination, to achieve the key management system in which the decryption of the transmitted information before the addition is permitted to certain newly added receivers and the decryption of the transmitted information before the addition is not permitted to other receivers.

(2.3) Contents Providing System of Embodiments

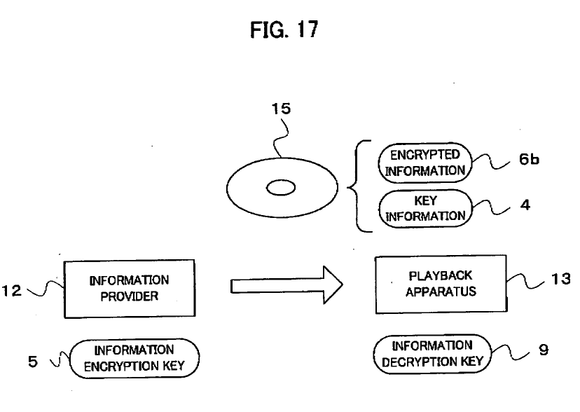

FIG. 17 shows a schematic construction of a contents providing system according to the embodiment of the invention. In this system, the information provider 12 provides various recording medium 15 to a user. In this embodiment, the recording medium 15 may be various recording medium including an optical disc such as DVD-ROM. The user has a playback apparatus 13, and plays back information from the recording medium 15 by the playback apparatus 13. The playback apparatus 13 has information decryption key 9 in its inside.

As shown in FIG. 1, the information provider 12 corresponds to the information transmitter of the three constitutive elements of the key management system, and the playback apparatus 13 corresponds to the information receiver. Namely, the information provider 12 encrypts the contents information such as video/audio by using the information encryption key 5, and records it on the recording medium as the encrypted information 6b. Also, the information provider 12 records the key information, on the recording medium 15, which cannot be decrypted by the revoked playback apparatus 13 but can be decrypted by the non-revoked playback apparatus 13. Then, the information provider 12 provides the recording medium 15 to each user of the playback apparatus 13.

It is noted that the key management center assigns the playback apparatuses 13 to the respective leaves constituting the tree structure by using the system expansion method of the first or second embodiment described above.

The non-revoked playback apparatus 13 decrypts the key information 4 by using its information decryption key 9 to obtain the decryption key of the encrypted information 6b, and decrypts the encrypted information 6b to play back the information such as video/audio. On the contrary, the revoked playback apparatus 13 cannot decrypt the key information 4 in the recording medium 15 by its information decryption key 9, and cannot obtain the key to decrypt the encrypted information 6b. Hence, it cannot play back the encrypted information 6b. In this way, in this system, the encrypted information 6b recorded on the recording medium 15 can be played back only by specific playback apparatuses 13.

In this invention, the information decryption key 9 on the side of the playback apparatus 13 and the key information 4 recorded on the recording medium 15 are generated in accordance with the key management system described in (1.3). Specifically, the playback apparatus 13 generates the information decryption key 9 from the key information 4 obtained from the recording medium 15, the confidential information (corresponding to the playback apparatus) given by the key management center and the public information. By using such a key management system, the information amount to be stored in the playback apparatus 13 can be reduced.

In the case that the playback apparatus 13 is assigned to the leaf constituting the tree by using the system expansion method according to the first or the second embodiment, the information amount of the confidential information and the public information are not different regardless of whether the playback apparatus 13 is added to the system early or lately. In the case that the system expansion method of the second embodiment is employed, the operation amount that the playback apparatus 13 calculates the encryption/decryption keys is the same for all the playback apparatuses 13.

(3) Specific Example of Contents Providing System

Next, a specific example of the contents providing system according to the embodiment of the invention will be described. This contents providing system uses an optical disc such as a DVD as the recording medium, and the example of a DVD-ROM will be described below. In this contents providing system, the information transmitter corresponds to a copyright holder or an optical disc manufacturing factory. On the other hand, the information receiver is an apparatus (playback apparatus) having a playback function of the contents, which is configured by a hardware or a software.

In the following description of the embodiment, “Encryption[ ]” indicates the encryption algorithm, and “Decryption[ ]” indicates the decryption algorithm. “Encryption [Argument1, Argument2]” indicates a cipher text obtained by encrypting Argument1 by using Argument2 as the encryption key, and “Decryption [Argument1, Argument2]” indicates the data obtained by decrypting Argument1 by using Argument2 as the decryption key. The symbol “|” indicates the concatenation of two data and used as “(DataA)|(DataB)”.

(3.1) Contents Recording Apparatus

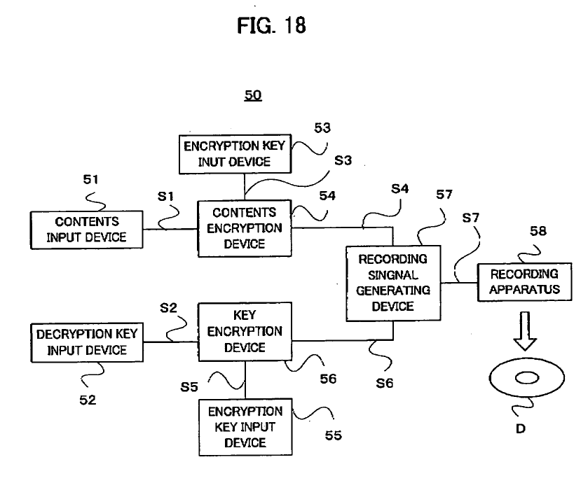

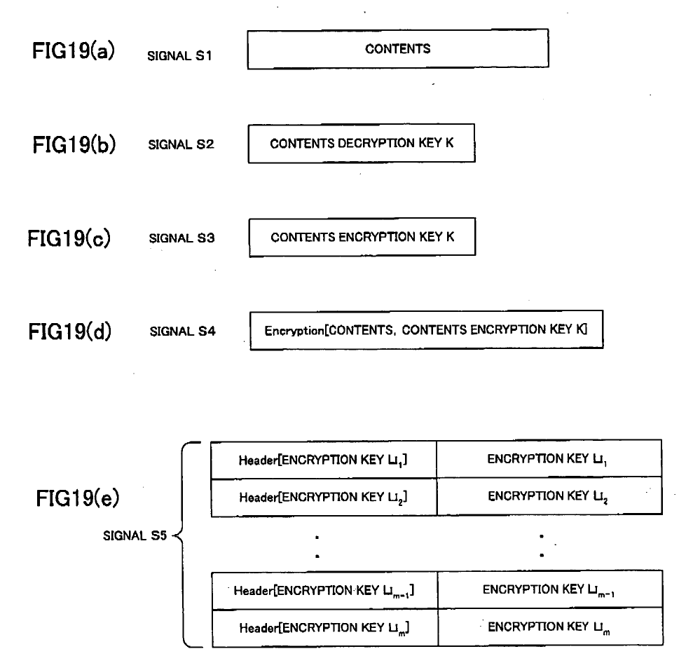

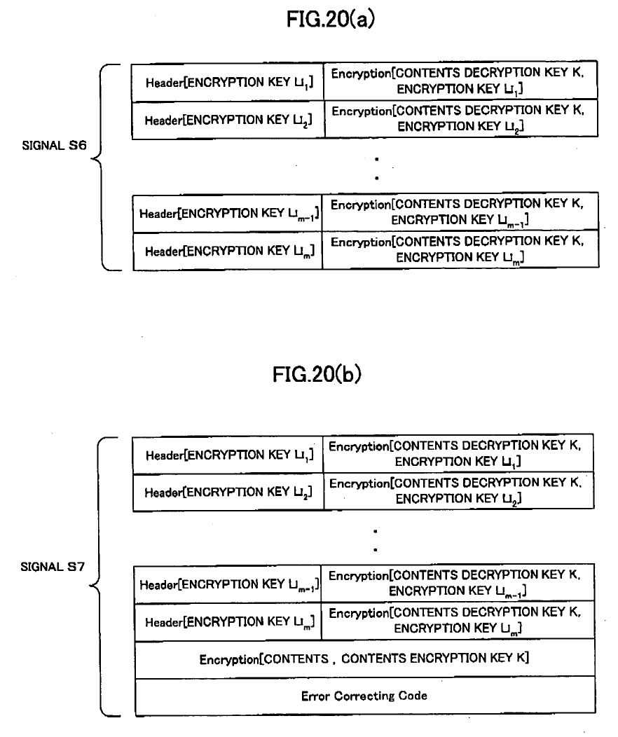

First, a contents recording apparatus will be described. FIG. 18 is a block diagram showing a construction of a contents recording apparatus 50 which records the contents on a disc. The contents recording apparatus 50 is provided in the above-mentioned disc manufacturing factory serving as the information transmitter. FIGS. 19 and 20 shows the signals S1 to S7 of each part of the contents recording apparatus 50. The contents here correspond to the above-mentioned encrypted information which is transmitted from the information transmitter to the information receiver.

In FIG. 18, the contents input device 51 is a device which inputs the contents, and outputs the signal S1 corresponding to the contents, as shown in FIG. 19(a). The typical example of the contents are generally multi-media data such as music, video and the like, but the contents here are not limited to those and may include data such as text. The contents input device 51 may be a circuit which reads a recording medium, such as a magnetic tape, a DVD-R, a DVD-RW, a DVD-ROM, a DVD-RAM on which master data of the contents are recorded, so as to output the signal S1, or a circuit which makes access via a communication line such as a LAN and the Internet to download the data and outputs the signal S1.

The decryption key input device 52 is a device which inputs the contents decryption key K, and outputs the signal S2 corresponding to the contents decryption key K as shown in FIG. 19(b). The contents decryption key K is determined by a copyright holder, a disc manufacturing factory or the key management center.

The encryption key input device 53 is a device which inputs the contents encryption key K, and outputs the signal S3 corresponding to the contents encryption key K as shown in FIG. 19(c). It is required that the contents encryption key K and the contents decryption key K have the following relationship:
P=Decryption[Encryption[Arbitrary Data P, Contents Encryption Key K], Contents Decryption Key]

The contents encryption device 54 encrypts the contents (the signal S1) by using the contents encryption key K (the signal S3), and outputs the encrypted contents as the signal S4. The signal S4 is shown in FIG. 19(d).

In this example, the contents are directly encrypted by using the contents encryption key K, it is not necessary to encrypt the contents itself. For example, the contents itself may be encrypted by other encryption key C, and the decryption key C corresponding to the encryption key C may be encrypted by the contents encryption key K and outputted as the signal S4. Namely, “Encrypting the contents by using the contents encryption key” described here means that the contents are converted in such a manner that at least the contents decryption key K is needed to decrypt the contents.

The encryption key input device 55 is a device which inputs plural encryption keys Lᵢ for encrypting the contents decryption key K, and chooses m encryption keys L_{I1}, L_{I2}, . . . , L_{Im-1}, L_{Im} according to the above-mentioned algorithm of the key management system to output the signal 55. The signal S5 is shown in FIG. 19(e). By the combination of the plural encryption keys L_{I1}, L_{I2}, . . . , L_{Im-1}, L_{Im}, the playback apparatus that can plays back the contents (the above-described “non-revoked receiver”) is uniquely determined. Therefore, the encryption key L_{Ii} is determined by an organization having a right to permit the playback (the key management center or the information transmitter). Header[Encryption key L_{I1}], Header[Encryption key L_{I2}], . . . , Header[Encryption key L_{Im-1}], Header[Encryption key L_{Im}] show the identification information of the encryption keys L_{I1}, L_{I2}, . . . , L_{Im-1}, L_{Im}, and are the same as the index part [i₁, i₂, . . . , iₘ] of the equations (1-2) and (1-3). Here, “Header[Encryption key L] ” is called the header of the encryption key L.

The key encryption device 56 encrypts the contents decryption key K obtained as the signal S2 by using the encryption key L_{Ii} obtained as the signal S5, and outputs the signal 36. FIG. 20(a) shows the signal S6. In the following description, for the sake of simplicity, the signal S6 is expressed as follows:
“Signal S6=Header[Encryption key L]|Encryption[Contents decryption key K, Encryption key K]”

The recording signal generating device 57 generates the recording signal by concatenating the encrypted contents and the contents decryption key K encrypted by the plural encryption keys L_{Ii}. More specifically, the recording signal generating device 57 concatenates the signal S4=Encryption[Contents, Contents encryption key K], the signal S6=Header[Encryption key L]|Encryption [Contents decryption key K, Encryption key L] and the error correction code, and outputs the result of the concatenation as the signal S7. Therefore, as shown in FIG. 20(b), the signal S7 includes the contents encrypted by the contents encryption key K, the contents decryption keys K encrypted by m encryption keys L_{Ii} and the error correction code. “ECC” is Error Correction Code.

The recording device 58 records the recording signal S7 thus generated onto the optical disc D, or cuts the recording signal 37 onto a master disc used to manufacture the optical discs. The recording device 58 normally includes a laser light source or a laser oscillator.

(3.2) Contents Playback Apparatus

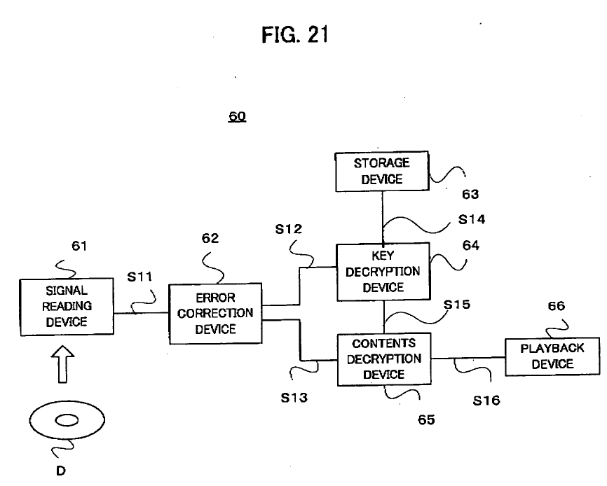

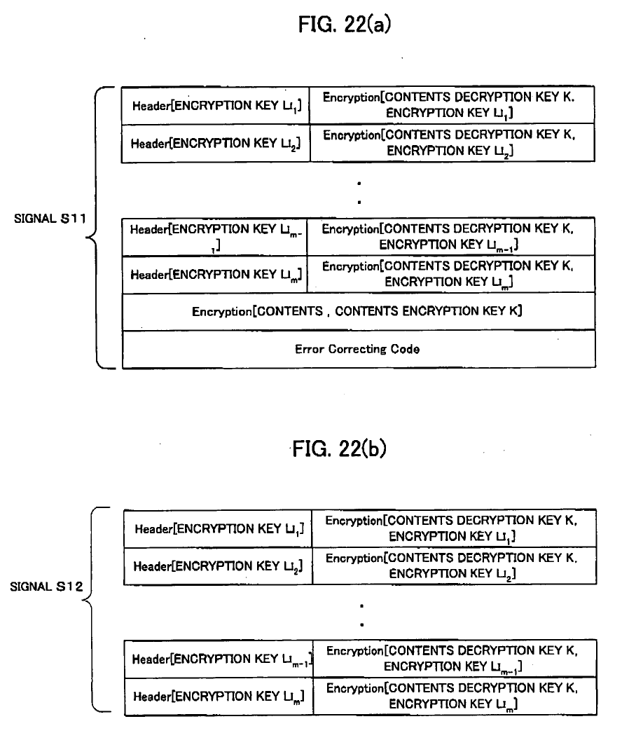

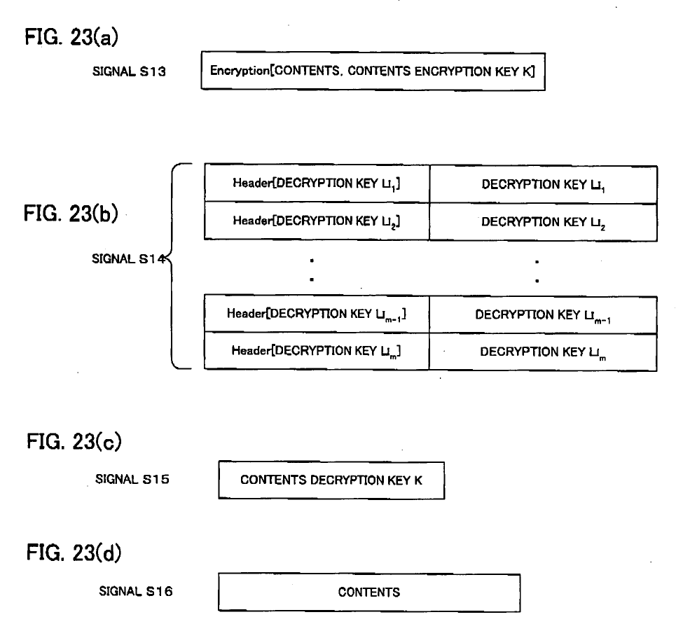

Next, the contents playback apparatus 60 which plays back the contents from the optical disc D on which the contents are recorded in the above-described manner will be described. FIG. 21 is a block diagrams showing the construction of the contents playback apparatus 60. FIGS. 22 and 23 show the signals of each part in the contents playback apparatus 60.

In FIG. 21, the information reading device 61 is a device such as an optical pickup, and reads the information recorded on the optical disc D to output the signal S11. The signal S11 is shown in FIG. 22(a).

The error correction device 62 is a device which performs the error correction of the inputted signal S11, and carries out the error correction based on the ECC included in the signal S11. Then, the error correction device 62 divides the signal after the error correction to the signals S12 and S13, and supplies them to the key decryption device 64 and the contents decoding device 65, respectively. The signal S12 is the data of the contents decryption key K encrypted by the encryption key Lᵢ, and is expressed by:
S12=Header[Encryption key B]|Encryption[Contents decryption key K, Encryption key L]
On the other hand, the signal S13 is the data of the contents encrypted by the content encryption key K, and is expressed by:
S13=Encryption[Contents, Contents encryption key K]

The storage device 63 stores plural decryption keys L_{J1}L_{J2}, . . . , L_{Jj}, . . . , L_{Jn-1}, L_{Jn} owned by the playback apparatus, and the headers Header[L_{J1}], Header[L_{J2}], . . . , Header[L_{Jj}], . . . , Header [L_{Jn-1}], Header [L_{Jn}]. Here, it is assumed that the storage device 63 stores n decryption keys. Also, the key management center distributes the decryption keys L_{Jj}, in advance, to the playback apparatuses such that either one of the encryption key L_{Ii} for encrypting the contents decryption key K and the decryption key L_{Jj} owned by the playback apparatus for which the playback is permitted satisfies the following relationship:
P=Decryption[Encryption[Arbitrary data P, Encryption key L_{Ii}], Decryption key L_{Jj}]
Further, the values of the headers are determined such that the headers added to the encryption key L_{Ii} and the decryption key L_{Jj} having the above relationship satisfy the following relationship:
Header[Encryption key L_{Ii}]=Header[Encryption key L_{Jj}]

It is the key management center that distributes the decryption key L_{Jj} and the header to each playback apparatus such that the above relationship is satisfied, and determines which decryption key K_{Jj} is distributed to which playback apparatus according to the algorithm of the above-described key management system.

As shown in FIG. 23(b), the storage device 63 outputs Decryption key L_{J1}|Decryption key L_{J2}| . . . |Decryption key L_{Jn-1}|Decryption key Lₙ and the headers Header[Decryption key L_{J1}]|Header[Decryption key L_{J2}]| . . . Header[Decryption key L_{Jn-1}]|[Header[Decryption key L_{Jn}].

The key decryption device 64 receives the signal S12=Header[Decryption key L|Encryption[Contents Decryption key K, Encryption key L], the signal S14=[Decryption key L_{J1}|Decryption key L_{J2}| . . . |Decryption key L_{Jn-1}|Decryption key L_{Jn}] and the headers Header[Decryption key L_{J1}]|Header[Decryption key L_{J2}]| . . . Header[Decryption key L_{Jn-1}]|[Header[Decryption key L_{Jn}], and examines whether or not the Header[Encryption key L_{Ii}] read from the optical disc and the Header[Decryption key L_{Jj}] owned by the playback apparatus coincide with each other. If they coincide with each other, the key decryption device 64 decrypts the Encryption[Contents Decryption key K, Encryption key L_{Ii}] by using the Decryption key L_{Jj}. Namely, Contents Decryption key K=Decryption[Encryption[Contents decryption key K, Encryption key L_{Ii}], Decryption key L_{Jj}]. This process is performed with changing the combination of Iᵢ and Jᵢ so that the combination of the coincident headers is found, and the signal S15=Contents decryption key K is outputted as shown in FIG. 23(c). Thus, the decrypted contents decryption key K is supplied to the contents decryption device 65 as the signal S15. On the other hand, if there is no combination of coincident headers, the playback is impossible and all processes are ended.

The contents decryption device 65 receives the signal S13=Encryption[Contents, Contents encryption key K] shown in FIG. 23(a) and the signal S15=Decryption[Encryption[Contents decryption key K, Encryption key Lᵢᵢ], Decryption key L_{Jj}]=Contents decryption key K shown in FIG. 23(c), decrypts the signal S13 by using the signal S15 and outputs Decryption[Encryption[Contents, Contents encryption key K], Contents decryption key K]=Contents as the signal S16. The playback device 66 plays back the contents decrypted by the contents decryption device 65. In this way, the contents is played back only by the playback apparatus for which the playback is permitted.

(3.3) Process in Key Management Center

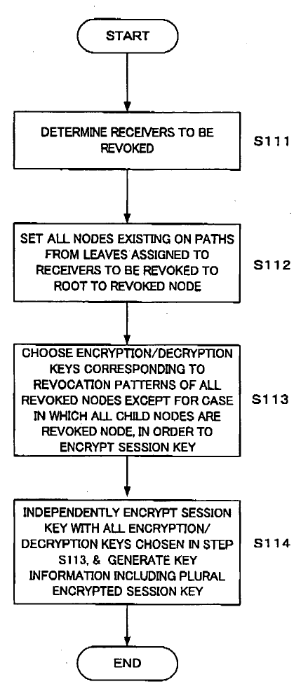

Next, the process in the key management center will be described with reference to FIGS. 24 to 29. There are cases that the process described below is performed by the information transmitter such as a copyright holder or a disc manufacturing factory.

The key management center functions as the above-described key management apparatus. The key management center includes a memory for storing information, a CPU for operation and the like. Namely, the memory the key management center has serves as the first to fifth storage units. Further, the CPU that the key management center has functions as the first and the second operation units. The key management center functions as the first and the second expansion unit for expanding the system.

In the following, the specific process performed by the key management center will be described.

(3.3.1) Key Information Generating Process

The key information generating process performed by the key management center will be described with reference to FIG. 24.

First, in step S111, the key management center determines the receivers to be revoked (i.e., the receivers for which the reception of the contents is not permitted).

Next, the nodes existing on the paths from the leaves to which the receivers chosen in step S111 are assigned to the root are all set to the revoked node (step S112). Then, the process goes to step S113.

Next, in step S113, in order to encrypt the session key, the encryption/decryption keys corresponding to the revocation patterns of all revoked nodes, except for the case that all the child nodes are the revoked nodes, are chosen.

Next, the session key is independently encrypted with all the encryption keys chosen in step S113 to generate the key information constituted by plural encrypted session keys (step S114). The key management center delivers the key information to the information transmitter.

(3.3.2) System Expansion Process

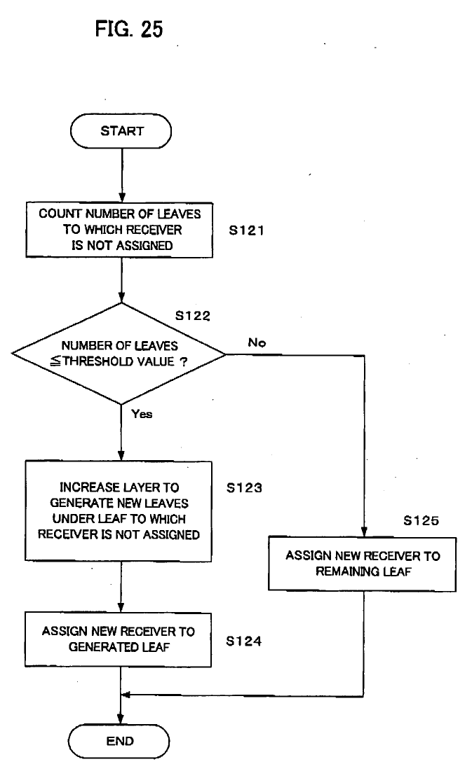

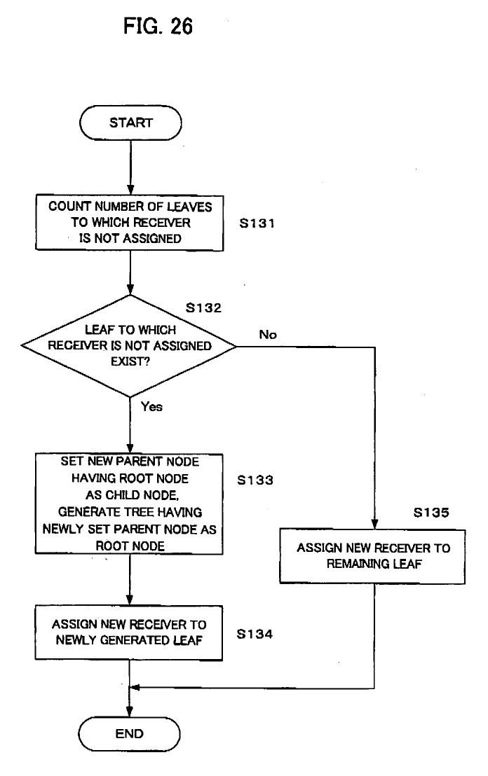

Here, the system expansion process performed by the key management system will be described with reference to FIGS. 25 and 26.

(a) Using System Expansion Method of First Embodiment

FIG. 25 is a flowchart of system expansion process by the key management system in the case that the system expansion method of the first embodiment is used. The following process is performed every time when a new receiver is added.

First, in step S121, the key management center counts the number of the leaves, in the tree used for the key management, to which receiver is not assigned. Then, the process goes to step S122.

In step S122, the key management center determines whether or not the number of the leaves thus counted is equal to or smaller than the threshold value. This threshold value is stored in advance in the memory or the like of the key management center.

If the number of the leaves is larger than the threshold value (step S122; No), the process goes to step S125. In step S125, the receiver is assigned to the remaining leaf. As mentioned, if the number of the leaves to which receiver is not assigned is larger than the threshold value, the tree is not expanded. When the above process ends, the process goes out of the flow.

On the contrary, if the number of the leaves is equal to or smaller than the threshold value (step S122; Yes), the process goes to step S123. In step S123, the key management center increases the layer to generate new leaves under the leaf to which receiver is not assigned. Since the number of the leaves to which receiver is not assigned is equal to or smaller than the threshold value, the tree is expanded. Then, the process goes to step S124. In step S124, the key management center assigns the receiver to the leave thus generated. When the above process ends, the process goes out of the flow.

If there is another receiver to be added, the above process is repeated again.

(b) Using System Expansion Method of Second Embodiment

FIG. 26 is a flowchart of system expansion process by the key management system in the case that the system expansion method of the second embodiment is used. The following process is performed every time when a new receiver is added.

First, in step S131, the key management center counts the number of the leaves, in the tree used for the key management, to which receiver is not assigned. Then, the process goes to step S132.

In step S132, the key management center determines whether or not there is a leaf to which receiver is not assigned, from the number of the leaves thus counted. The above determination is performed because the tree is expanded when the receivers are assigned to all the leaves of the tree (i.e., when there is no leaf to which receiver is not assigned) in the system expansion method of the second embodiment.

If there is a leaf to which receiver is not assigned (step S132; No), the process goes to step S135. In step S135, the receiver is assigned to the remaining leaf. When the above process ends, the process goes out of the flow.

On the contrary, if there is no leaf to which receiver is not assigned (step S132; Yes), the process goes to step S133. In step S133, the key management center sets a new parent node which includes the root node as a child node, and generate a tree which has the newly set parent node as the root node. Here, if the tree used for the key management is “a”-divided tree, there are “a” patterns to set the root node before the expansion as the child node, but any pattern may be used. In the example of FIG. 14(c), the leftmost pattern is used from three patterns (i.e., leftmost pattern, center pattern and the rightmost pattern). Then, the process goes to step S134.

In step S134, the key management center assigns the receiver to the leaf of the newly generated tree. When the above process ends, the process goes out of the flow.

If there is another receiver to be added, the above process is repeated again.

(3.3.3) Assigning Process of Encryption/Decryption Keys to Subsets

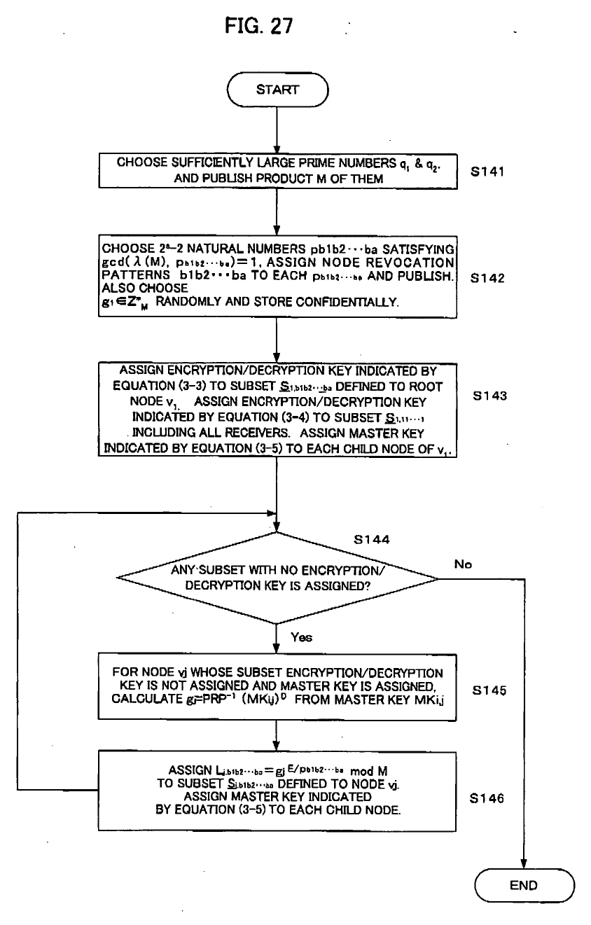

Next, the description will be given of the assigning process, performed by the key management center, of encryption/decryption keys to the subsets defined to the node will be described with reference to the flowchart shown in FIGS. 27 to 29.

(a) Before Expansion of System

By referring to FIG. 27, the encryption key assigning process performed by the key management center, described in (1.3), will be described. Here, the description will be given of the process to assign the encryption/decryption keys to the nodes constituting the tree for which the system is not expanded (i.e., before the system expansion).

First, in step S141, the key management center chooses two large prime numbers (e.g., larger than 512 bits) q₁ and q₂, and publishes the product M of them as the public information. Then, the process goes to step S142.

In step S142, the key management center chooses 2^{a}-2 natural numbers p_{b1b2 . . . ba} (e.g., prime numbers) which are relatively prime and which satisfy the equation (3-1), assigns each p_{b1b2 . . . ba} to the node revocation patterns b1b2 . . . ba, and publishes the p_{b1b2 . . . ba} and this assignment as the public information. Further, the key management center chooses g₁∈Z*_{M} at random. Here, Z*_{M} is a set of residue class rings Z_{M}={0, 1, . . . , M−1} having a positive integer M as a modulus and relatively prime to M. This is called “irreducible residue class”, and forms group in respect of multiplication. Also, “g₁” is confidentially stored by the key management center. Then, the process goes to step S143.

In step S143, the key management center assigns the encryption/decryption keys L_{1,b1b2 . . . ba} to be assigned to 2^{a}-2 subsets S_{1,b1b2 . . . ba} defined to the root node v₁ as the equation (3-3). To the set S_{1,11 . . . 1} including all the receivers, the encryption key indicated by the equation (3-4) is assigned. Also, to each child node vⱼ (j=2 . . . a+1) of v₁, the master key MK_{1,j} given by the equation indicated by the equation (3-5) is assigned. Then, the process goes to step S144.

In step S144, the key management center determines whether there exists a subset to which the encryption/decryption key is not assigned, or not. If there is no such subset (step S144; No), the key management center has already assigned the encryption keys to all the subsets, and hence the encryption/decryption key assigning process to the subsets ends.

On the contrary, if there is a subset to which the encryption/decryption key is not assigned (step S144; Yes), the process goes to step S145. For the node vⱼ to whose subset defined that the encryption key is not assigned and the master key is assigned, the key management center calculates gⱼ=PRP⁻¹(MK_{i,j})^{D} from the master key MK_{i,j} assigned to itself (e.g., calculates by the equation (3-10)). Then, the process goes to step S146.

In step S146, the encryption/decryption keys L_{j,b1b2 . . . ba} are assigned to the subsets S_{j,b1b2 . . . ba} defined to the node Vⱼ by using gⱼ obtained as described above, and the master key indicated by the equation (3-5) is assigned to each child node. Then, the process goes back to step S144 to repeat the same process. When the encryption/decryption keys are assigned to all the subsets, the process from step S144 to S146 ends.

In this way, the information transmitter can calculate the encryption key assigned to the subset using the key information, and the information receiver such as the playback apparatus can calculate the decryption key assigned to the subset by obtaining the key information from the information transmitter.

(b) After System Expansion Process of First Embodiment

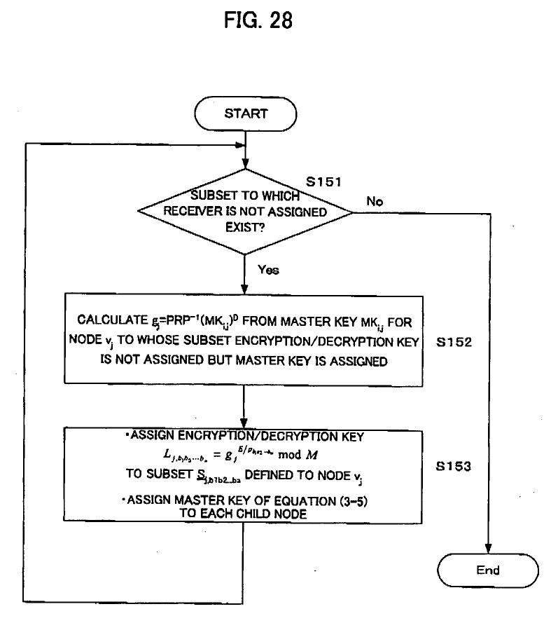

Next, the description will be given of the process of assigning the encryption/decryption keys after the key management process of the first embodiment, with reference to FIG. 28. The following process assumes that the encryption/decryption keys have already been assigned to the subsets which are assigned to the nodes constituting the tree for which the system is not expanded (i.e., before the system expansion).

First, in step S151, the key management center determines whether or not there is a subset to which encryption/decryption key is not assigned. It there is no such subset (step S151; No), the key management center has already assigned the encryption/decryption keys to all the subsets, and hence the assigning process of the encryption/decryption keys to the subset ends.

On the contrary, if there is a subset to which encryption/decryption key is not assigned (step S151; Yes), the process goes to step S152. For the node vⱼ to whose subset defined that the encryption key is not assigned and the master key is assigned, the key management center calculates gⱼ=PRP⁻¹(MK_{i,j})^{D} from the master key MK_{i,j} assigned to itself (e.g., calculates as the equation (3-10)). For example, in the case of FIG. 12 before the system expansion (only the nodes exist in Layer0 to Layer2), the above node is one of v₅, v₆ and v₇. Assuming that v₅ is selected, g₅=PRP⁻¹ (MK_{4,5})^{D} is calculated from the master key MK_{4,5} assigned to v₅. Then, the process goes to step S153.

In step S153, the encryption/decryption keys L_{j,b1b2 . . . ba} are assigned to the subsets S_{j,b1b2 . . . ba} defined to the node vⱼ by using gⱼ thus obtained, and the master key indicated by the equation (3-5) is assigned to each child node of vⱼ. For example, as to the node v₅ in FIG. 12, the encryption/decryption keys L_{5,100}, L_{5,010}, L_{5,001}, L_{5,110}, L_{5,101}, L_{5,011} are assigned to the subsets S_{5,100}, S_{5,010}, S_{5,001}, S_{5,110}, S_{5,101}, S5,011 defined to the node v₅ by using the gⱼ thus obtained, and the master key indicated by the equation (3-5) is assigned to each child node of v₅. Then, the process goes back to step S151, and the process is repeated. When the encryption/decryption keys are assigned to all the subsets, the process from step S151 to S153 ends.

As described above, by using the system expansion method of the first embodiment, the key management center assigns the common public information and one confidential information to all the receivers, and therefore the information amount stored in the receiver do not depend on the layer to which the receivers belong.

(c) After System Expansion Process of Second Embodiment

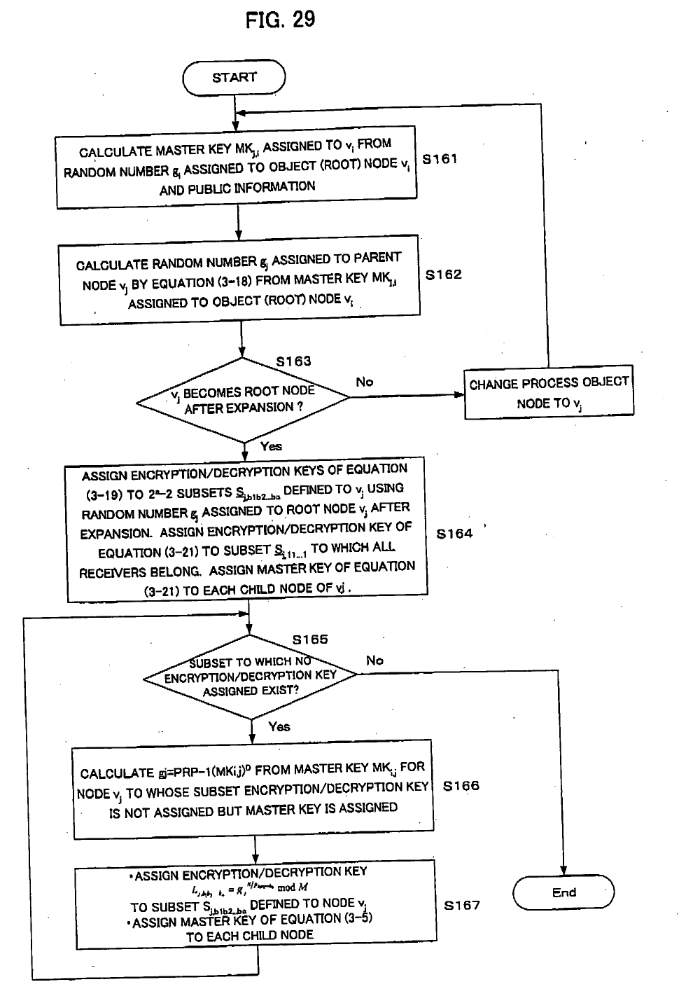

Next, the process of assigning the encryption/decryption keys after the key management process of the second embodiment will be described with reference to FIG. 29. The following process assumes that the encryption/decryption keys have already been assigned to the subsets which are assigned to the nodes constituting the tree for which the system is not expanded (i.e., before the system expansion). In the following algorithm, a term “process object node” is used, which at first indicates the root node v₃.

First, in step S161, the key management center derives the master keys MK_{j,i} of the process object node vᵢ, by the equation (3-17), from the random number gⱼ assigned to the process object node vᵢ and the public information. Then, the process goes to step S162.
MK_{j,i}=PRP(gᵢ^{g}mod M) (3-17)

In step S162, the random number gⱼ to be assigned to the parent node vⱼ of vᵢ is derived from the master keys MK_{j,i} of the process object node vᵢ by the equation (3-18). Then, the process goes to step S163.

$${g}_{j} = MK \text{?} mod M \\ \text{?} \text{indicates text missing or illegible when filed} \qquad ( 3 \text{-} 18 )$$

In step S163, it is determined whether or not the node vⱼ becomes the root node after the expansion. If it is not the root node (step S163; No), the process object node is changed to vⱼ, and the process goes back to step S161.

On the contrary, if the node vⱼ becomes the root node after the expansion (steps 163; Yes), the process goes to step S164. In step S164, by using the random number gⱼ derived in step S162, the encryption/decryption keys L_{j,b1b2 . . . ba} to be assigned to the 2^{a}-2 subsets S_{j,b1b2 . . . ba} defined to the node vⱼ are assigned by the equation (3-19). The encryption/decryption key given by the equation (3-21) is assigned to the subset S_{1,11 . . . 1} including all the receivers. Also, the master keys MK_{j,k} given by the equation (3-20) are assigned to each child node vₖ (k=j+1, . . . , j+1+a) of vⱼ.
L_{j,b}_{₁}_{b}_{₂} _{. . . b}_{ₐ}=gⱼ^{E/pb}^{₁}^{b}^{₂}^{. . . b}^{ₐ}mod M (3-19)
MK_{j,k}=gⱼ^{E/Πp}^{₁}mod M (3-20)
L_{j,11 . . . 1}=gⱼ^{E}mod M (3-21)

In step S165, the key management center determines whether or not the subset to which the encryption/decryption key is not assigned exists in the subsets defined to the nodes existing under the node vⱼ. If such subset does not exist (step S165; No), the key management center has already assigned the encryption/decryption keys to all the subsets defined under the node vⱼ, and therefore the assigning process of the encryption/decryption keys to the subsets ends.

On the contrary, if there exists the subset to which the encryption/decryption key is not assigned (step S165; Yes), the process goes to step S166. In step S166, for the node v_{d} to which the encryption key is not assigned and the master key is assigned, the key management center calculates g_{d}=PRP⁻¹(MK_{c,d})^{D} from the master key MK_{c,d} assigned to itself (e.g., calculates as the equation (3-10)). Then, the process goes to step S167.

In step S167, the encryption/decryption keys L_{d,b1b2 . . . ba} are assigned to the subsets S_{d,b1b2 . . . ba} defined to the node V_{d} by using g_{d} obtained as described above, and the master key indicated by the equation (3-5) is assigned to each child node. Then, the process goes back to step S165 to repeat the same process. When the encryption/decryption keys are assigned to all the subsets, the process from step S165 to S167 ends.

As described above, if the system expansion method of the second embodiment is used, since all the receivers belong to the same layer, the number of the encryption/decryption keys that the receiver should calculate becomes the same. Therefore, there is no difference in the computational amount to calculate the encryption/decryption keys between the receivers. In addition, similarly to the case of using the system expansion method of the first embodiment, there is no difference in the information amount of the public information and the confidential information stored in the receivers.

(3.4) Process performed by Information Transmitter

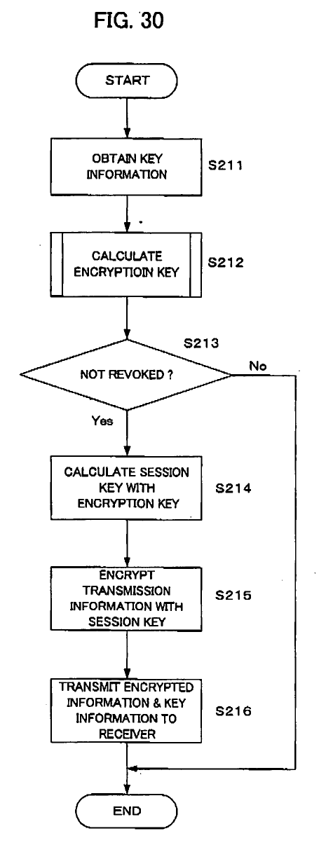

The outline of the contents encryption process performed by the information transmitter will be described with reference to FIG. 30. This process is performed by the contents recording apparatus 50 described above.

First, in step S211, the contents recording apparatus 50 obtains the key information from the key management center. The contents recording apparatus 50 may obtain the key information via a communication medium. If the contents recording apparatus 50 owns the key information in advance, the process of step S211 is not performed.

Next, the process of step S212 is performed when the information providing system is the system shown in FIG. 2 or FIG. 3. Therefore, the process of step S212 is not performed in the information providing system shown in FIG. 1. The contents recording apparatus 50 obtains the confidential information and the public information as well as the key information from the key management center (the public information can also be obtained from the public bulletin board), and calculates the encryption keys from them. If the information transmitter is revoked, the encryption key cannot be derived. However, the process goes out of this flow in S213 in that case, and hence there is no problem. The encryption keys can be derived by substituting the confidential information and the public information for the equation (3-6). When the above process is completed, the process goes to step S213.

In step S213, the contents recording apparatus 50 judges whether the information transmitter (contents recording apparatus 50) is not revoked. If the information transmitter is revoked (step S213; No), the process goes out the flow and ends. The step S213 may be placed before step S212. In that case, the revoked information transmitters are excluded in advance, the encryption key is necessarily derived in step S212.

If the information transmitter is not revoked (step S213; Yes), the process goes to step S214. The contents recording apparatus 50 calculates the session key (i.e., information encryption key) by using the encryption key calculated in step S212. Then, the process goes to step S215.

In step S215, the contents recording apparatus 50 encrypts the transmission information by using the session key calculated in step S214 to produce encrypted information. Then, the process goes to step S216, and the contents recording apparatus 50 transmits the encrypted information and the key information to the information receiver.

(3.5) Process Performed by Information Receiver

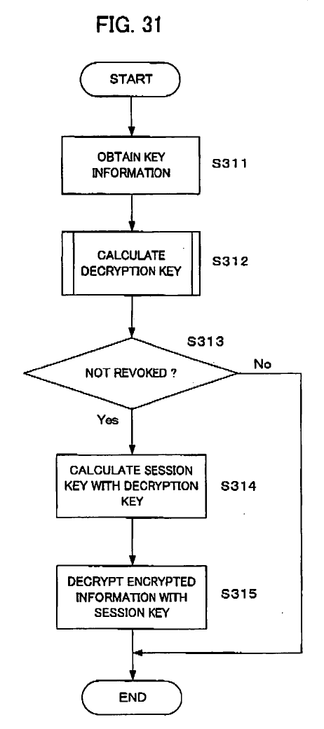

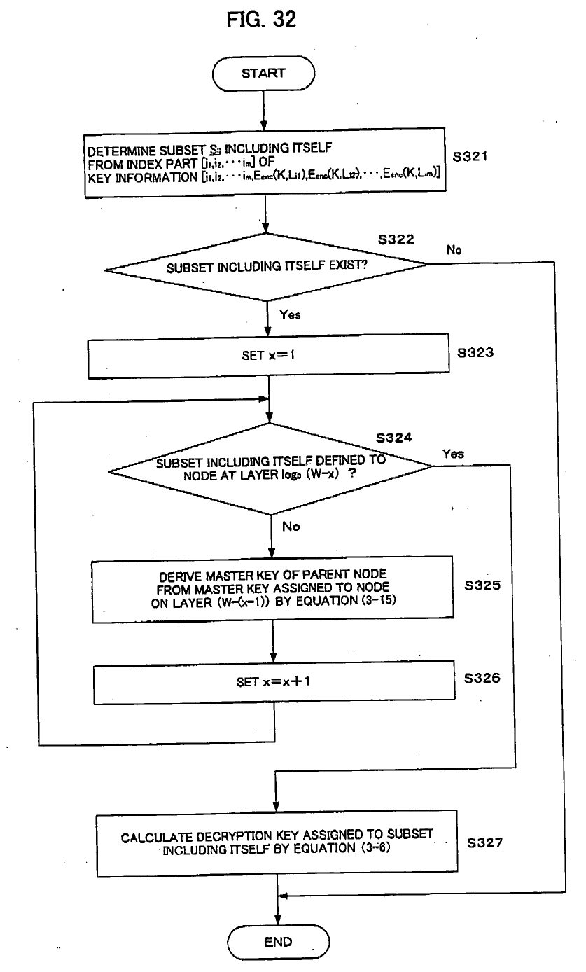

Next, the process performed by the information receiver will be described with reference to FIGS. 31 and 32. The information receiver may be the above-described contents playback apparatus 60, for example.

(3.5.1) Contents Decryption Process

The outline of the contents decryption process performed by the contents playback apparatus 60 will be described with reference to FIG. 31. The contents decryption process is a reverse process of the contents encryption process performed by the information transmitter, and is substantially the same process.

First, in step S311, the contents playback apparatus 60 obtains the encrypted information and the key information from the recording medium, such as an optical disc, on which the contents are recorded. The contents playback apparatus 60 may obtain them via a communication medium.

Next, in step S312, the contents playback apparatus 60 calculates the decryption keys by using the confidential information and the public information stored in the contents playback apparatus 60 and the obtained key information. If the information receiver is revoked, the decryption key cannot be derived. However, in that case, the process goes out of the flow in step S313, and hence there is no problem. In the case of the information providing system shown in FIG. 3, the contents playback apparatus 60 obtains the public information from the public bulletin board. The decryption key can be derived by substituting the confidential information and the public information for the equation (3-6). If the information receiver is revoked, the decryption key can not be derived. However, the process goes out of this flow in S313 in that case, and hence there is no problem. The detailed description of calculating the decryption key in step S312 will be omitted. When the above process is completed, the process goes to step S313.

In step S313, the contents playback apparatus 60 judges whether the contents playback apparatus 60 itself is not revoked. If the contents playback apparatus 60 is revoked (step S313; No), the process goes out of the flow and ends. Step S313 may be performed before step S312. In that case, the revoked information receivers are excluded in advance, the decryption key is necessarily derived in step S312.

If the contents playback apparatus 60 is not revoked (step S312; Yes), the process goes to step S314. The contents playback apparatus 60 calculates the session key (i.e., information decryption key) by using the decryption key calculated in step S312. Then, the process goes to step S315.

In step S315, the contents playback apparatus 60 decrypts the encrypted information by using the session key calculated in step S314 to produce received information. In this way, the contents playback apparatus 60 decrypts the encrypted information.

(3.5.2) Process of Calculating Decryption Key-I

The process of calculating the decryption keys in step S312 in FIG. 31 will be specifically described with reference to FIG. 32. Although the calculation of the decryption keys in step S312 and the determination whether or not the information receiver is revoked in step S313 are described as separate processes in FIG. 31, those two processes will be described together. This process is performed by the contents playback apparatus 60. Also, this process derives the decryption keys defined by the key management system described in the first embodiment.

First, in step S321, the contents playback apparatus 60 judges the subset Sᵢⱼ to which the contents playback apparatus 60 itself is included, from the index part [i₁, i₂, . . . , iₘ] (i.e., the above-described header part) of the key information [i₁, i₂, . . . , iₘ, E_{enc}[K,Lᵢ₁], E_{enc}(K,Lᵢ₂), . . . E_{enc}(K,Lᵢₘ)]. Then, the process goes to step S322.

In step S322, the contents playback apparatus 60 judges whether or not the subset to which the contents playback apparatus 60 itself belongs exists in the key information. Namely, the contents playback apparatus judges whether the contents playback apparatus 60 itself, is revoked or not with respect to the playback of the contents. If such subset does not exist (step S322; No), the process of calculating the decryption key ends.

On the other hand, if there exists the subset to which the contents playback apparatus 60 belongs (step S322; Yes), the process goes to step S323, and the contents playback apparatus 60 sets the counter x=1. This counter is stored in the memory in the contents playback apparatus 60. Then, the process goes to step S324.

In step S324, the contents playback apparatus 60 determines whether or not the subset to which the contents playback apparatus 60 itself belongs, determined bin step S321, is defined to the node existing at the layer (W-x). Here, “W” is the layer including the leaf to which the receiver is assigned. According to the key management system described (1.3), the master keys are sequentially calculated from the lower layer to the upper layer, and the decryption keys are calculated by the master keys thus derived. Therefore, the calculation from the lower layer to the upper layer ends when the master key, with which the decryption key Lᵢⱼ assigned to the subset Sᵢⱼ determined in step S321 can be derived by the equation (3-6), is derived, Namely, in step S324, it is determined whether or not the master key, with which the decryption key used to the decryption of the key information according to the equation (3-6) can be derived, is obtained.

If the subsets to which the contents playback apparatus 60 itself belongs is not defined to the node existing at the layer (W-x) (step S324; No), the process goes to step S325. The contents playback apparatus 60 derives, from the master key assigned to the node on the layer (W-x), the master key of the parent node according to the equation (3-22). At this time, if x=1, the confidential information stored in the contents playback apparatus 60 is used as the master key. In order to calculate the decryption key, the master key thus obtained is stored in the memory in the contents playback apparatus 60. Then, the process goes to step S326.

$$MK \text{?} = PRP ( MK \text{?} mod M ) \\ \text{?} \text{indicates text missing or illegible when filed} \qquad ( 3 \text{-} 22 )$$

In step S326, the contents playback apparatus 60 updates the counter x=x+1. Then, the process goes back to step S324, and the above process is repeated until the master key, with which the decryption key for decrypting the key information can be derived by the equation (3-6), is obtained.

If the subsets to which the contents playback apparatus 60 itself belongs is defined to the node existing at the layer (W-x) (step S324; Yes), the process goes to step S327, wherein the decryption key assigned to the subset to which the contents playback apparatus 60 itself belongs is calculated by the equation (3-6). Thus, the contents playback apparatus 60 calculates the decryption key.

When the contents recording apparatus 50 calculates the encryption key (i.e., the process in step S212 in FIG. 30), the contents recording apparatus 50 can perform the same process as described above.

### INDUSTRIAL APPLICABILITY

The key management system according to the present invention is applicable to various products, such as a DVD player, a DVD recorder, a PDP, a portable music player and a PC, which handles copyright contents via a certain communication medium such as an optical disc or a network.

The invention may be embodied on other specific forms without departing from the spirit or essential characteristics thereof. The present embodiments therefore to be considered in all respects as illustrative and not restrictive, the scope of the invention being indicated by the appended claims rather than by the foregoing description and all changes which come within the meaning an range of equivalency of the claims are therefore intended to embraced therein.

The entire disclosure of Japanese Patent Application No. 2004-147985 filed on May 18, 2004 including the specification, claims, drawings and summary is incorporated herein by reference in its entirety.

What is claimed is:

1. A key management apparatus for generating key information in association with a tree structure which has at least one root node and in which plural nodes are assigned under a node as leaves, comprising:
a first storage unit which stores natural numbers relatively prime to each other, as public information, in association with subsets expressed by a combination of plural leaves corresponding to each of nodes constituting the tree structure;
a second storage unit which stores master keys in association with the leaves corresponding to the node;
a third storage unit which stores encryption/decryption key in association with the subset;
a unit which assigns receivers to lowest nodes of the tree structure;
a first expansion unit which expands a new leaf to one of the lowest nodes of the tree structure to which the receiver is not assigned and assigns the encryption/decryption key to the new leaf.

2. The key management apparatus according to claim 1, further comprising:
a fourth storage unit which stores a composite number which is a product of more than one arbitrary prime numbers;
a fifth storage unit which stores confidential information which is an arbitrary natural number which is smaller than the composite number and which is relatively prime to the composite number, in association with the root node;
a first operation unit which calculates the master key by a bijective function from the confidential information and the public information; and
a second operating unit which calculates the encryption/decryption key based on the master key and the public information.

3. A key management apparatus for generating key information in association with a tree structure which has at least one root node and in which plural nodes are assigned under a node as leaves, comprising:
a first storage unit which stores natural numbers relatively prime to each other, as public information, in association with subsets expressed by a combination of plural leaves corresponding to each of nodes constituting the tree structure;
a second storage unit which stores master keys in association with the leaves corresponding to the node;
a third storage unit which stores encryption/decryption key in association with the subset; and
a second expansion unit which generates a new node having the root node as a leaf, adds a tree structure having the new node as the root node, and calculates master keys to be assigned to each nodes of the added tree structure.

4. The key management apparatus according to claim 3, further comprising:
a fourth storage unit which stores a composite number which is a product of more than one arbitrary prime numbers;
a fifth storage unit which stores confidential information which is an arbitrary natural number which is smaller than the composite number and which is relatively prime to the composite number, in association with the root node;
a first operation unit which calculates the master key by a bijective function from the confidential information and the public information; and
a second operating unit which calculates the encryption/decryption key based on the master key and the public information.

5. A key management method for generating key information in association with a tree structure which has at least one root node and in which plural nodes are assigned under a node as leaves, comprising:
a first storage process which stores natural numbers relatively prime to each other, as public information, in association with subsets expressed by a combination of plural leaves corresponding to each of nodes constituting the tree structure;
a second storage process which stores master keys in association with the leaves corresponding to the node;
a third storage process which stores encryption/decryption key in association with the subset;
a process which assigns receivers to lowest nodes of the tree structure;
a first expansion process which expands a new leaf to one of the lowest nodes of the tree structure to which the receiver is not assigned and assigns the encryption/decryption key to the new leaf.

6. A key management method for generating key information in association with a tree structure which has at least one root node and in which plural nodes are assigned under a node as leaves, comprising:
a first storage process which stores natural numbers relatively prime to each other, as public information, in association with subsets expressed by a combination of plural leaves corresponding to each of nodes constituting the tree structure;
a second storage process which stores master keys in association with the leaves corresponding to the node;
a third storage process which stores encryption/decryption key in association with the subset; and
a second expansion process which generates a new node having the root node as a leaf, adds a tree structure having the new node as the root node, and calculates master keys to be assigned to each nodes of the added tree structure.

7. A key management program product executed on a computer, the program product allows the computer to function as a key management apparatus for generating key information in association with a tree structure which has at least one root node and in which plural nodes are assigned under a node as leaves, comprising:
a first storage unit which stores natural numbers relatively prime to each other, as public information, in association with subsets expressed by a combination of plural leaves corresponding to each of nodes constituting the tree structure;
a second storage unit which stores master keys in association with the leaves corresponding to the node;
a third storage unit which stores encryption/decryption key in association with the subset;
a unit which assigns receivers to lowest nodes of the tree structure;
a first expansion unit which expands a new leaf to one of the lowest nodes of the tree structure to which the receiver is not assigned and assigns the encryption/decryption key to the new leaf.

8. A key management program product executed on a computer, the program product allows the computer to function as a key management apparatus for generating key information in association with a tree structure which has at least one root node and in which plural nodes are assigned under a node as leaves, comprising:
a first storage unit which stores natural numbers relatively prime to each other, as public information, in association with subsets expressed by a combination of plural leaves corresponding to each of nodes constituting the tree structure;
a second storage unit which stores master keys in association with the leaves corresponding to the node;
a third storage unit which stores encryption/decryption key in association with the subset; and
a second expansion unit which generates a new node having the root node as a leaf, adds a tree structure having the new node as the root node, and calculates master keys to be assigned to each nodes of the added tree structure.
